(19) United States
(12) Patent Application Publication
(10) Pub. No.: US 2013/0222883 A1
(43) Pub. Date: Aug. 29, 2013

(54) DISPLAY PARTICLES, DISPLAY PARTICLE DISPERSION LIQUID, DISPLAY MEDIUM, AND DISPLAY DEVICE

(71) Applicants: Fuji Xerox Co., Ltd., (US); Fujifilm Corporation, (US)

(72) Inventors: Hiroshi KAYASHIMA, Minamiashigara-shi (JP); Jun KAWAHARA, Minamiashigara-shi (JP); Shigeaki OHTANI, Kanagawa (JP); Yoshio TADAKUMA, Kanagawa (JP)

(73) Assignees: FUJIFILM CORPORATION, Tokyo (JP); FUJI XEROX CO., LTD., Tokyo (JP)

(21) Appl. No.: 13/718,431

(22) Filed: Dec. 18, 2012

(30) Foreign Application Priority Data
Feb. 27, 2012 (JP) 2012-040368

(51) Int. Cl. C08L 25/02; G02F 1/167

(52) U.S. Cl. CPC C08L 25/02; G02F 1/167
USPC 359/296; 526/284; 526/329.2; 526/312; 524/553; 524/555; 524/562; 526/279

(57) ABSTRACT

There is provided a display particles including: a copolymer having a repeating unit corresponding to a vinyl compound represented by the following Formula (1) and a repeating unit corresponding to a compound with a polar group and an ethylenically unsaturated bond:

ArH₂C═CH₂)ₙ Formula (1)
wherein Ar represents an unsubstituted aromatic ring or an aromatic ring substituted with an alkyl group having from 1 to 6 carbon atoms or an aryl group having from 6 to 12 carbon atoms, and n represents an integer of from 1 to 4.

### CROSS-REFERENCE TO RELATED APPLICATION(S)

This application is based on and claims priority under 35 U.S.C. §119 from Japanese Patent Application No. 2012-040368 filed on Feb. 27, 2012.

### BACKGROUND

1. Technical Field

The present invention relates to display particles, a display particle dispersion liquid, a display medium, and a display device.

2. Related Art

Hitherto, display mediums using migrating particles are known as repeated rewritable display mediums. The display medium is configured to include, for example, a pair of substrates and particles which are included between the substrates so as to be freely moved therebetween in accordance with an electric field formed between the pair of substrates. In addition, the display medium may include particles (e.g., white particles) having a low migration speed according to the electric field between the substrates in some cases in order to display a background color (e.g., white).

For example, JP-A-2008-145713 proposes “polymer grafted particles for electrophoresis to be dispersed in an electrophoretic dispersion liquid, which include pigment particles to which a polymer is grafted by 16 to 100 mass % of the pigment”.

For example, Patent JP-A-2001-125147 proposes “a display liquid for an electrophoretic display consisting of a dispersion medium and at least one kind of color particles having different tone from that of the dispersion medium, which contains a polymer type surfactant”.

For example, JP-A-06-100701 proposes “a composite granular pigmentary material which consists of a combined material of at least two kinds of chemically distinct materials, i.e., a first material whose particles have a positive surface charge and a second material whose particles have a negative surface charge, in which the particles of the first material are combined with the particles of the second material and held as a result of the above-described surface charges”.

For example, JP-A-2008-122468 proposes “composite particles which include white or color particles coated with a resin and in which the white or color particles can be dispersed in a dispersion medium by using a dispersant and the resin includes a polymer produced by the reaction of a reactive group in the dispersant molecule adsorbed to the white or color particles with at least one kind of monomer, and is not dissolved in the dispersion medium”.

An object of the invention is to provide display particles which have suppressed field responsiveness.

### SUMMARY

The object is resolved by the following configurations. That is,

(1) Display particles including: a copolymer having a repeating unit corresponding to a vinyl compound represented by the Formula (1) and a repeating unit corresponding to a compound with a polar group and an ethylenically unsaturated bond:

ArH₂C═CH₂)ₙ Formula (1)
wherein Ar represents an unsubstituted aromatic ring or an aromatic ring substituted with an alkyl group having from 1 to 6 carbon atoms or an aryl group having from 6 to 12 carbon atoms, and n represents an integer of from 1 to 4.

### BRIEF DESCRIPTION OF THE DRAWINGS

Exemplary embodiments of the present invention will be described in detail based on the following figures, wherein:

FIG. 1 is a schematic diagram illustrating a configuration of a display device according to a first exemplary embodiment;

FIG. 2A schematically illustrates a moving mode of a particle group when a voltage is applied between substrates of a display medium of the display device according to the first exemplary embodiment;

FIG. 2B schematically illustrates a moving mode of a particle group when a voltage of an opposite polarity is applied between substrates of a display medium of the display device according to the first exemplary embodiment.

FIG. 3 is a schematic diagram illustrating a configuration of a display device according to a second exemplary embodiment;

FIG. 4 is a diagram schematically illustrating the relationship between an applied voltage and the degree of movement (display density) of particles in the display device according to the second exemplary embodiment; and

FIG. 5 schematically illustrates the relationship between a mode of a voltage which is applied between substrates of a display medium and a moving mode of particles.

### DETAILED DESCRIPTION

In this specification, “(meth)acrylic” denotes both “acrylic and methacrylic”, and “(meth)acrylate” denotes both “acrylate and methacrylate”.

Display Particles

Hereinafter, two exemplary embodiments of display particles according to this exemplary embodiment will be described.

Display Particles According to First Exemplary Embodiment

Display particles according to a first exemplary embodiment include a copolymer as a constituent element which includes a vinyl compound (hereinafter, also referred to as “specific vinyl compound”) represented by the following Formula (1) and a compound (hereinafter, also referred to as “polar group-containing polymerization component”) having a polar group and an ethylenically unsaturated bond as polymerization components.

ArH₂C═CH₂)ₙ Formula (1)

In Formula (1), Ar represents an unsubstituted aromatic ring or an aromatic ring substituted with an alkyl group having from 1 to 6 carbon atoms or an aryl group having from 6 to 12 carbon atoms. n represents an integer of from 1 to 4.

By virtue of the above-described configuration, the display particles according to the first exemplary embodiment are provided with suppressed field responsiveness.

For example, migrating particles which migrate in accordance with the electric field and particles for displaying a background color (hereinafter, referred to as “particles for background color display”) are used in a display medium. It is preferable that the particles for background color display have low field responsiveness and maintain a floating state in a dispersion medium even in the electric field. When the particles for background color display have high field responsiveness, the electrophoretic speed according to the electric field is high, and as a result, the particles for background color display migrate toward a display surface side of the display medium together with other colors of migrating particles, whereby this causes mixed-color display.

In this regard, it is thought that the display particles according to the first exemplary embodiment have a lower charge quantity and lower field responsiveness than particles formed of a polymer which includes the specific vinyl compound as a polymerization component, but does not include the polar group-containing polymerization component as a polymerization component, even though it is not known exactly why.

Therefore, it is thought that the display particles according to the first exemplary embodiment has a low electrophoretic speed according to the electric field, that is, are difficult to migrate, and thus mixed-color display which is caused by the field responsiveness of the particles is suppressed.

Examples of the display particles according to the first exemplary embodiment include display particles (1) in which a copolymer including a specific vinyl compound and a polar group-containing polymerization component as polymerization components is independently granulated and display particles (2) in which a granular product of a copolymer including a specific vinyl compound and a polar group-containing polymerization component as polymerization components includes color particles.

Since the material of the above-described display particles (1) is a material in which the copolymer including a specific vinyl compound and a polar group-containing polymerization component as polymerization components tends to exhibit a high refractive index, the particles (1) can be used as white display particles.

In addition, in the above-described display particles (1), when color particles are not included, the specific gravity of the display particles is low, and thus the display particles are unlikely to sink when being dispersed in a dispersion medium and easily maintain a floating state in the dispersion medium.

The above-described display particles (2) are display particles in which, for example, color particles are dispersed and included in a granulated copolymer including a specific vinyl compound and a polar group-containing polymerization component as polymerization components. The above-described display particles (2) can take a tone according to the color of the included color particles.

Display Particles According to Second Exemplary Embodiment

Display particles according to a second exemplary embodiment have color particles and a covering layer which covers the color particles and includes a copolymer as a constituent element which includes a specific vinyl compound and a polar group-containing polymerization component as polymerization components.

Here, the covering means that the copolymer covers at least a part of the surface of a color particle.

By virtue of the above-described configuration, the display particles according to the second exemplary embodiment are provided with suppressed field responsiveness.

Hitherto, display mediums use color particles having a color corresponding to a tone to be displayed as display particles. However, some color particles have a high charge quantity, so when such color particles are used as particles for background color display, the field responsiveness of the particles for background color display is high and mixed-color display may occur. For example, when the background color is set to white, inorganic white particles such as titanium oxide particles are used as particles for background color display. However, since the charge quantity of the inorganic white particles is high, the inorganic white particles have high field responsiveness and a high migration speed according to the electric field, thereby causing mixed-color display.

On the other hand, it is thought that in the display particles according to the second exemplary embodiment, the color particles are covered with the covering layer which includes a copolymer as a constituent element which includes a specific vinyl compound and a polar group-containing polymerization component as polymerization components, and the charge quantity of the covering layer is low, whereby the field responsiveness is low.

Therefore, it is thought that the display particles according to the second exemplary embodiment have a low migration speed according to the electric field, that is, are difficult to migrate, thereby suppressing mixed-color display which is caused by the field responsiveness of the particles.

The display particles according to the second exemplary embodiment can take a tone according to the color of the included color particles.

In the display particles according to the second exemplary embodiment, the content ratio of the color particles to the entire display particles is not particularly limited. For example, the content ratio is preferably 30% by mass or greater from the viewpoint that the display particles exhibit a tone according to the color of the included color particles, and preferably 90% by mass or less from the viewpoint that the specific gravity is suppressed to realize particles which are unlikely to sink in a dispersion medium. For example, when white particles (e.g., titanium oxide particles) are used as color particles, the content ratio of the color particles is preferably 30% by mass or greater from the viewpoint of realizing a high degree of whiteness, and preferably 90% by mass or less, and more preferably from 40% by mass to 80% by mass from the viewpoint that the specific gravity is suppressed to realize particles which are unlikely to sink in a dispersion medium.

The content ratio of the color particles is obtained, for example, as follows. One method is that the produced particles are subjected to centrifugal settling to measure the mass, thereby calculating the ratio of the amount of the material of the color particles. The content ratio may be calculated through particle composition analysis or thermogravimetric analysis.

The covering ratio (the ratio of the surface covered with the copolymer to the whole surface of the color particles) of the display particles according to the second exemplary embodiment is not particularly limited. The covering ratio is preferably 50% or greater from the viewpoint of reducing the field responsiveness of the display particles, and more preferably from 70% to 100%.

Hereinafter, the constituent elements of the display particles according to the first exemplary embodiment and the second exemplary embodiment and the raw material components included in the constituent elements will be described.

Vinyl Compound Expressed by Formula (1)

The specific vinyl compound is a vinyl compound represented by the above-described Formula (1).

In the above-described Formula (1), Ar represents an unsubstituted aromatic ring or an aromatic ring substituted with an alkyl group having from 1 to 6 carbon atoms or an aryl group having from 6 to 12 carbon atoms. The aromatic ring may be monocyclic or polycyclic, and may also be condensed. For example, it may be a group having n hydrogen atoms taken from benzenes (monocyclic aromatic hydrocarbons); polycyclic aromatic hydrocarbons having a single bond of a plurality of benzene atoms such as biphenyls and triphenyls; condensed-ring aromatic hydrocarbons such as naphthalene, phenalene, phenanthrene, anthracene, triphenylene, pyrene, chrysene, and tetracene; compounds having a single bond of two or more selected from the polycyclic aromatic hydrocarbons and the condensed-ring aromatic hydrocarbons; compounds having a single bond of a plurality of benzene atoms through an alkyl group having from 1 to 6 carbon atoms (a linear or branched-chain alkyl group such as a methyl group, an ethyl group, an n-propyl group, an isopropyl group, an n-butyl group, an isobutyl group, a sec-butyl group, a tert-butyl group, a pentyl group, and a hexyl group); compounds having a single bond of two or more selected from the polycyclic aromatic hydrocarbons and the condensed-ring aromatic hydrocarbons through an alkyl group having from 1 to 6 carbon atoms (a linear or branched-chain alkyl group such as a methyl group, an ethyl group, an n-propyl group, an isopropyl group, an n-butyl group, an isobutyl group, a sec-butyl group, a tert-butyl group, a pentyl group, and a hexyl group); or the like.

Among them, a group having n hydrogen atoms taken from benzenes, biphenyls, or naphthalenes is preferably used as the aromatic ring from the viewpoint that the charge quantity of the particles including a copolymer as a constituent element which includes a specific vinyl compound and a polar group-containing polymerization component as polymerization components is low.

The aromatic ring may be substituted with an alkyl group having from 1 to 6 carbon atoms or an aryl group having from 6 to 12 carbon atoms. Examples of the alkyl group having from 1 to 6 carbon atoms include a methyl group, an ethyl group, an n-propyl group, an isopropyl group, an n-butyl group, an isobutyl group, a sec-butyl group, a tert-butyl group, a pentyl group, a hexyl group, and the like. Examples of the aryl group having from 6 to 12 carbon atoms include a phenyl group, a tolyl group, a mesityl group, a benzyl group, a xylyl group, a naphthyl group, and the like.

In the above-described Formula (1), n represents an integer of from 1 to 4, and is preferably 1 or 2.

The specific vinyl group is preferably at least one kind selected from styrene: the following Structural Formula (1-1), divinylbenzene: the following Structural Formula (1-2), vinylbiphenyl: the following Structural Formula (1-3), divinylbiphenyl: the following Structural Formulas (1-4) and (1-5), vinylnaphthalene: the following Structural Formula (1-6), and divinylnaphthalene: the following Structural Formulas (1-7) and (1-8). The above-described copolymer including these specific vinyl compounds is more preferable than the above-described copolymer including a specific vinyl compound other than the specific vinyl compounds from the viewpoints that the particles are easily formed, the charge quantity of the particles is low, and the refractive index is high.

In the divinylbenzene, vinylbiphenyl, divinylbiphenyl, vinylnaphthalene, and divinylnaphthalene, the position of one or two vinyl groups is not particularly limited.

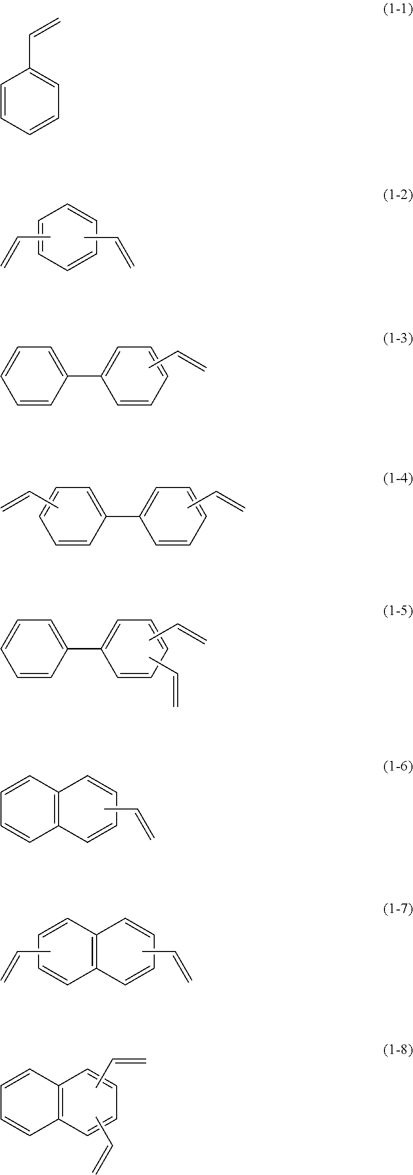

The specific vinyl compounds which are represented by the above-described Structural Formulas (1-1) to (1-8) have the same characteristics as polymerization components, and copolymers including any of them as a polymerization component have the same characteristics. Among them, specific vinyl compounds represented by Structural Formulas (1-1), (1-2), (1-3), and (1-6) are easily available.

Compound Having Polar Group and an Ethylenically Unsaturated Bond The polar group-containing polymerization component is a compound having a polar group and an ethylenically unsaturated bond. The polar group may be any of an acid group, a neutral group, and a basic group.

Examples of the polar group-containing polymerization component having an acidic polar group (hereinafter, also referred to as “acid group-containing polymerization component”) include ethylenically unsaturated compounds having any of a carboxylic group, a sulfo group, a phosphate group, and a formyl group, and the like.

Examples of the ethylenically unsaturated compounds having a carboxylic group include (meth)acrylic acids, fumaric acids, maleic acids, itaconic acids, cinnamic acids, monomethyl maleates, 1-[2-(methacryloyloxy)ethyl]phthalate, and the like.

Examples of the ethylenically unsaturated compounds having a sulfo group include 2-((meth)acryloyloxy)ethanesulfonate.

Examples of the ethylenically unsaturated compounds having a phosphate group include 2-((meth)acryloyloxy)ethyl phosphate, and the like.

Examples of the polar group-containing polymerization component having a neutral polar group (hereinafter, also referred to as “neutral group-containing polymerization component”) include ethylenically unsaturated compounds having any of a hydroxy group, an amide group, a cyano group, and the like.

Examples of the ethylenically unsaturated compounds having a hydroxy group include 2-hydroxyethyl(meth)acrylate, and the like.

Examples of the ethylenically unsaturated compounds having an amide group include (meth)acrylamide, and the like.

Examples of the ethylenically unsaturated compounds having a cyano group include 2-cyanoethyl(meth)acrylate, and the like.

Examples of the polar group-containing polymerization component having a basic polar group (hereinafter, also referred to as “basic group-containing polymerization component”) include ethylenically unsaturated compounds having an amino group.

Examples of the ethylenically unsaturated compounds having an amino group include 2-(diethylamino)ethyl(meth)acrylate, 2-(dimethylamino)ethyl(meth)acrylate, and the like.

Acid group-containing polymerization components are preferably used as the polar group-containing polymerization component from the viewpoint of adjusting the charge quantity, and among them, ethylenically unsaturated compounds having a carboxylic group are preferably used, and (meth)acrylic acids are more preferably used.

Regarding the polar group-containing polymerization component, one kind may be used alone, or two or more kinds may be used in combination.

Other Polymerization Components

The copolymer of the display particles according to the first exemplary embodiment and the second exemplary embodiment may include other polymerization components, as well as the specific vinyl compound and the polar group-containing polymerization component as polymerization components. Examples of the other polymerization components include compounds having a silicone chain and polymerization components having an alkyl chain (monomers having an alkyl chain).

Examples of the compounds having a silicone chain include dimethyl silicone compounds having a (meth)acrylate group at one terminal (silicone compounds represented by the following Structural Formula (A), e.g., SILAPLANE: FM-0711, FM-0721, and FM-0725 all manufactured by Chisso Corporation, and X-22-174DX, X-22-2426, and X-22-2475 all manufactured by Shin-Etsu Chemical Co., Ltd.), silicone compounds represented by the following Structural Formula (B), silicone compounds represented by the following Structural Formula (C), and the like.

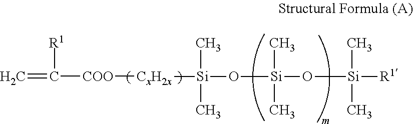

In Structural Formula (A), R¹ represents a hydrogen atom or a methyl group. R^{1′} represents a hydrogen atom or an alkyl group having from 1 to 4 carbon atoms. m represents a natural number (for example, from 1 to 1000, and preferably from 3 to 100). x represents an integer of from 1 to 3.

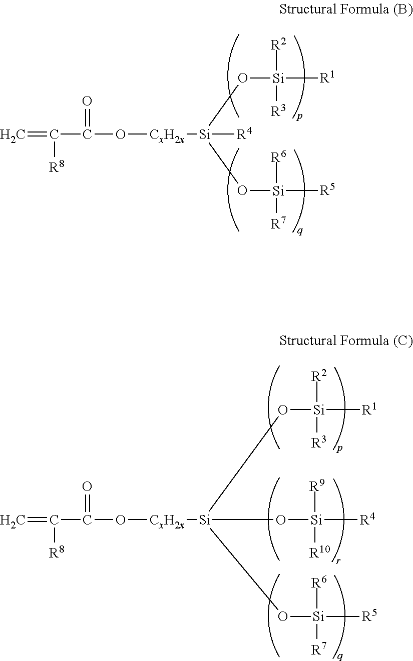

In Structural Formulas (B) and (C), each of R¹, R², R³, R⁴, R⁵, R⁶, R⁷, R⁹, and R¹⁰ independently represents a hydrogen atom, an alkyl group having from 1 to 4 carbon atoms, or a fluoroalkyl group having from 1 to 4 carbon atoms. R⁸ represents a hydrogen atom or a methyl group. Each of p, q, and r independently represents an integer of from 1 to 1000. x represents an integer of from 1 to 3.

In Structural Formula (B), it is preferable that R¹ and R⁵ represent a butyl group, R², R³, R⁴, R⁶, and R⁷ represent a methyl group, R⁸ represent a methyl group, each of p and q independently represents an integer of from 1 to 5, and x represent an integer of from 1 to 3.

In Structural Formula (C), it is preferable that R¹, R², R³, R⁴, R⁵, R⁶, R⁷, R⁹, and R¹⁰ represent a methyl group, R⁸ represent a hydrogen atom or a methyl group, each of p, q, and r independently represents an integer of from 1 to 3, and x represents an integer of from 1 to 3.

Examples of the monomers represented by Structural Formula (B) include MCS-M11 manufactured by Gelest, and the like. Examples of the monomers represented by Structural Formula (C) include RTT-1011 manufactured by Gelest, and the like. The structural formulas of the monomers will be shown as follows.

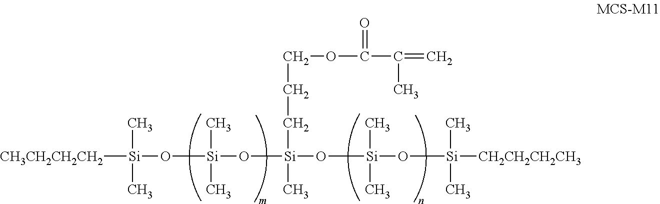

Regarding MCS-M11, each of m and n in the above-described structural formula independently represents an integer of from 2 to 4, and the molecular weight thereof is from 800 to 1000.

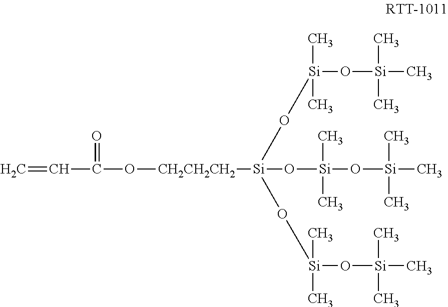

RTT-1011 is a compound represented by the above-described structural formula.

Examples of the polymerization components having an alkyl chain (monomers having an alkyl chain) include (meth)acrylic esters. Specific examples thereof include methyl(meth)acrylate, butyl(meth)acrylate, hexyl(meth)acrylate, octyl(meth)acrylate, dodecyl(meth)acrylate, stearyl(meth)acrylate, 2-ethylhexyl(meth)acrylate, and the like. Among them, (meth)acrylic esters having a long-chain alkyl chain, e.g., an alkyl chain having from 4 to 30 carbon atoms are preferably used.

In the above-described copolymer, the content ratio of the polar group-containing polymerization component to the whole copolymer is preferably 0.001% by mass or greater, more preferably 0.1% by mass or greater, even more preferably 1% by mass or greater, still more preferably 5% by mass or greater, and even still more preferably 10% by mass or greater from the viewpoint of suppressing the field responsiveness of the particles. Also, the upper limit of the content ratio of the polar group-containing polymerization component to the whole copolymer is preferably 20% by mass or less.

The content ratio of the specific vinyl compound to the whole copolymer is preferably 5% by mass or greater, more preferably 10% by mass or greater, and even more preferably 20% by mass or greater from the viewpoint of forming the particles by precipitating a resin in a particle-dispersed solvent. Also, the upper limit of the content ratio of the specific vinyl compound to the whole copolymer is preferably 75% by mass or less, more preferably 65% by mass or less, and even more preferably 55% by mass or less.

When the above-described copolymer includes a compound having a silicone chain, the content ratio of the compound having a silicone chain may be, for example, from 5% by mass to 50% by mass, and preferably from 10% by mass to 40% by mass with respect to the whole copolymer.

Color Particles

The color of the color particles is not particularly limited, and color particles having a color corresponding to the background color of a display medium are selected.

Examples of the color particles include organic pigments, inorganic pigments; glass beads; insulating metal oxide particles such as alumina and titanium oxide; thermoplastic or thermosetting resin particles; thermoplastic or thermosetting resin particles with a coloring agent (organic pigments, inorganic pigments, dyes, and the like) fixed to the surfaces thereof; particles of thermoplastic or thermosetting resins containing an insulating coloring agent (organic pigments, inorganic pigments, dyes, and the like); metal colloid particles having a plasmon coloring function; and the like.

The raw material component of particles of a particle group 34 which is used as an example of a display device to be described later and the manufacturing method thereof may be employed as a raw material component of the color particles and a method of manufacturing the color particles.

Among the color particles, for example, inorganic white particles are used as white particles. Examples of the inorganic white particles include metal oxide particles such as titanium oxide particles, silicon oxide particles, zinc oxide particles, and tin oxide particles. Among them, titanium oxide particles are favorable from the viewpoint of increasing the refractive index and realizing display having a high degree of whiteness.

Next, the characteristics of the display particles according to the first exemplary embodiment and the second exemplary embodiment will be described.

The volume average particle diameter of the display particles may be, for example, from 0.1 μm to 10 μm, is preferably from 0.15 μm to 5 μm, and more preferably from 0.15 μm to 1 μm.

The volume average particle diameter of the particles is a value measured using a particle diameter analyzer (FPAR-1000, manufactured by Otsuka Electronics Co., Ltd.).

As for the charge quantity of the display particles, for example, the total charge quantity per display area at a concentration of 1.5% by mass may be from 0.5 nC/cm² to 50 nC/cm², is preferably from 1 nC/cm² to 30 nC/cm², and more preferably from 1 nC/cm² to 20 nC/cm².

Next, the method of manufacturing the display particles according to the first exemplary embodiment and the second exemplary embodiment will be described. The method of manufacturing the display particles is not particularly limited, but for example, the following methods are used.

Method of Manufacturing Display Particles According to First Exemplary Embodiment

First, raw material components of the above-described copolymer, and as necessary, other additives such as a polymerization initiator are added to and mixed with an organic solvent, thereby preparing a mixed solution.

Thereafter, for example, the mixed solution is heated to conduct a polymerization reaction of the raw material components of the above-described copolymer.

Next, the reaction solution after the polymerization reaction is dripped to a solvent having a property of not dissolving the above-described copolymer to precipitate the above-described copolymer, thereby obtaining the above-described copolymer as a precipitate.

Next, the above-described copolymer is dissolved in a solvent having a property of dissolving the above-described copolymer and a dispersion medium (e.g., silicone oil) which is used for a display medium is dripped to the solvent to precipitate the above-described copolymer, thereby forming particles of the above-described copolymer.

Accordingly, a liquid in which the particles having the above-described copolymer as a constituent element are dispersed is obtained.

When including color particles in a granular product of the above-described copolymer, the display particles according to the first exemplary embodiment are manufactured using, for example, the following manufacturing methods.

Examples thereof include a method which includes kneading and pulverizing the above-described copolymer obtained as a precipitate in the above-described manufacturing process and color particles; a method which includes polymerizing raw material components of the above-described copolymer in a solution in which color particles coexist to aggregate the materials; a method which includes polymerizing raw material components of the above-described copolymer and subsequently adding color particles thereto to aggregate the materials; and the like.

Method of Manufacturing Display Particles According to Second Exemplary Embodiment

First, raw material components of the above-described copolymer, and as necessary, other additives such as a polymerization initiator are added to and mixed with an organic solvent, thereby preparing a mixed solution.

Thereafter, for example, the mixed solution is heated to conduct a polymerization reaction of the raw material components of the above-described copolymer.

Next, the reaction solution after the polymerization reaction is dripped to a solvent having a property of not dissolving the above-described copolymer to precipitate the above-described copolymer, thereby obtaining the above-described copolymer as a precipitate.

Next, the above-described copolymer is dissolved in a solvent having a property of dissolving the above-described copolymer and color particles are added thereto and dispersed using a dispersion unit (e.g., zirconia beads or a rocking mill), thereby obtaining a color particle dispersion liquid.

Thereafter, a dispersion medium (e.g., silicone oil) which is used for a display medium is dripped to the color particle dispersion liquid to precipitate the above-described copolymer on the surfaces of the color particles, thereby forming particles in which the surfaces of the color particles are covered with the above-described copolymer.

Accordingly, a liquid in which the particles having the color particles which are covered with a covering layer including the above-described copolymer as a constituent element are dispersed is obtained.

Display Particle Dispersion Liquid

A display particle dispersion liquid according to this exemplary embodiment has a particle group including the display particles according to this exemplary embodiment and a dispersion medium for dispersing the particle group.

The display particle dispersion liquid may include other display particles (migrating particles) as the particle group. In addition, if necessary, acids, alkalis, salts, dispersants, dispersion stabilizers, stabilizers for antioxidation, ultraviolet absorption, and the like, antimicrobial agents, preservative agents, and the like may be added to the display particle dispersion liquid.

Although various dispersion mediums which are used for a display medium are applied as the dispersion medium, a low-dielectric solvent (having a dielectric constant of, for example, 5.0 or less, and preferably 3.0 or less) is preferably selected. Although solvents other than the low-dielectric solvents may be used in combination for the dispersion medium, a low-dielectric solvent of 50% by volume or greater is preferably included. The low dielectric constant is obtained using a dielectric constant measuring unit (manufactured by Nihon Rufuto Co., Ltd.).

Examples of the low-dielectric solvents include paraffin-based hydrocarbon solvents, silicone oils, and petroleum-derived high-boiling point solvents such as fluorine-based liquids. The low-dielectric solvent may be selected in accordance with the kind of the copolymer which is a constituent element of the display particles according to this exemplary embodiment.

Specifically, for example, when a copolymer which includes a compound having a silicone chain as a polymerization component is applied, silicone oils may be selected as the dispersion medium. When a copolymer which includes a polymerization component having an alkyl chain as a polymerization component is applied, paraffin-based hydrocarbon solvents may be selected as the dispersion medium. Of course, the low-dielectric solvent is not limited thereto.

Specific examples of the silicone oils include silicone oils in which a hydrocarbon group is bonded to a siloxane bond (e.g., dimethyl silicone oil, diethyl silicone oil, methyl ethyl silicone oil, methyl phenyl silicone oil, diphenyl silicone oil, and the like). Among them, dimethyl silicone oil is particularly preferably used.

Examples of the paraffin-based hydrocarbon solvents include normal paraffin-based hydrocarbons and isoparaffin-based hydrocarbons having 20 or more carbon atoms (boiling point of 80° C. or higher). However, isoparaffin-based hydrocarbons are preferably used because of safety, volatility, and the like. Specific examples thereof include SHELLSOL 71 (manufactured by Showa Shell Sekiyu K.K.), ISOPAR-O, ISOPAR-H, ISOPAR-K, ISOPAR-L, ISOPAR-G and ISOPAR-M (trade name, manufactured by Exxon Mobile Corporation), IP SOLVENT (manufactured by Idemitsu Kosan Co., Ltd.), and the like.

Examples of charge controlling agents include ionic or nonionic surfactants, block or graft copolymers having a lipophilic part and a hydrophilic part, compounds having a polymer chain structure such as a cyclic, stellate, or dendritic polymer (dendrimer), metal complexes of salicylic acids, metal complexes of catechol, metal-containing bisazo dyes, tetraphenyl borate derivatives, polymerizable silicone macromers (SILAPLANE, manufactured by Chisso Corporation), copolymers with an anion monomer or a cation polymer, and the like.

Specific examples of the ionic or nonionic surfactants are as follows. Examples of the nonionic surfactants include polyoxyethylene nonyl phenyl ether, polyoxyethylene octyl phenyl ether, polyoxyethylene dodecyl phenyl ether, polyoxyethylene alkyl ether, polyoxyethylene fatty acid ester, sorbitan fatty acid ester, polyoxyethylene sorbitan fatty acid ester, fatty acid alkylol amide, and the like. Examples of the anionic surfactants include alkylbenzenesulfonate, alkylphenylsulfonate, alkylnaphthalenesulfonate, higher fatty acid salt, sulfuric acid ester salt of higher fatty acid ester, sulfonic acid of higher fatty acid ester, and the like. Examples of the cation surfactants include primary to tertiary amine salt, quaternary ammonium salt, and the like. These charge controlling agents are preferably used in an amount of from 0.01% by mass to 20% by mass with respect to the particle solid content, and particularly preferably used in an amount of from 0.05% by mass to 10% by mass.

The display particles and the display particle dispersion liquid according to this exemplary embodiment are used in an electrophoresis type display medium and the like.

Display Medium, Display device

An example of a display medium and an example of a display device according to this exemplary embodiment will be described. The following examples are examples in which the display particles according to this exemplary embodiment are applied as white display particles, and the display particles according to this exemplary embodiment will be described as white display particles.

### First Exemplary Embodiment

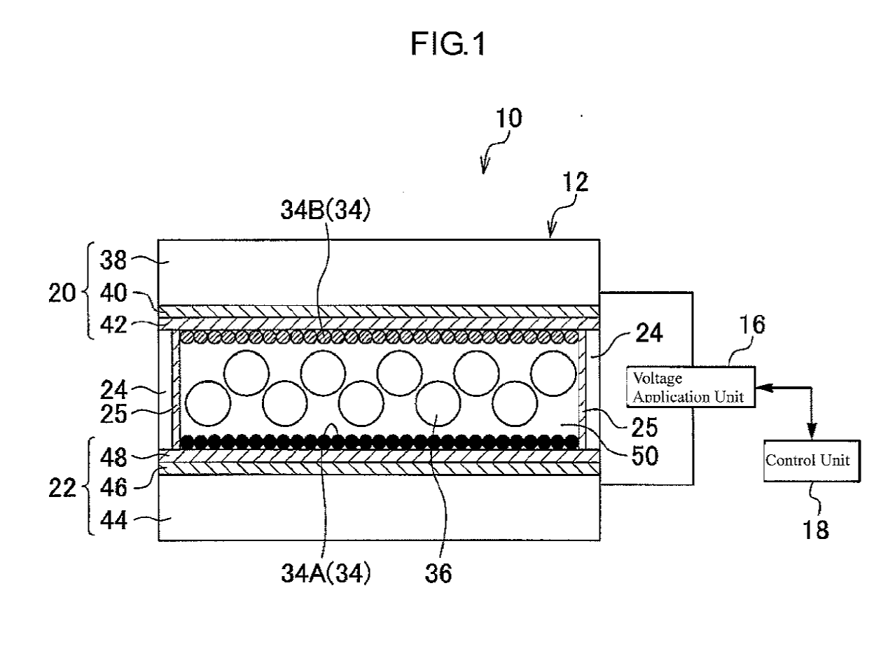

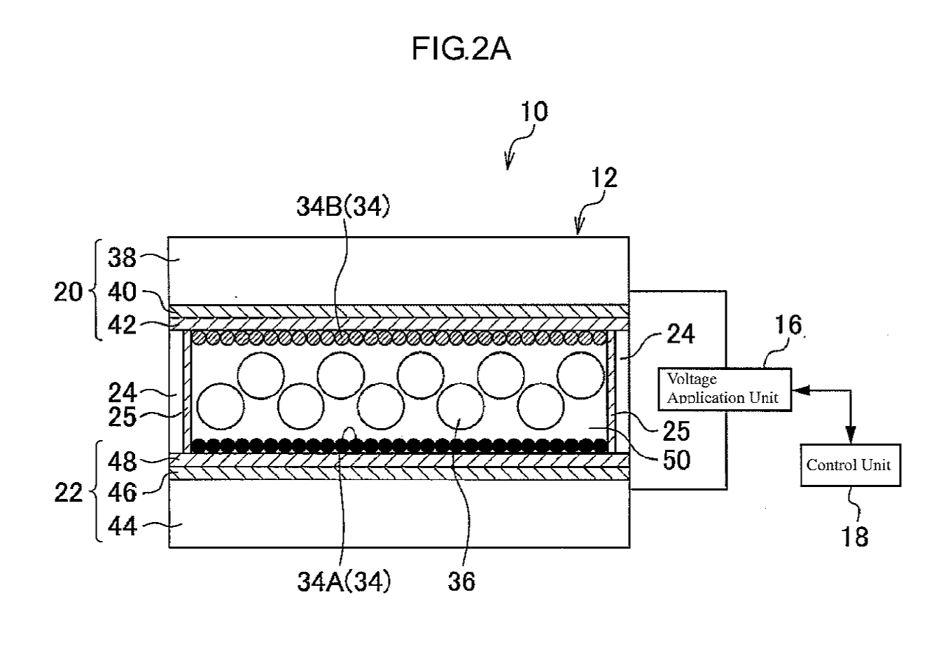

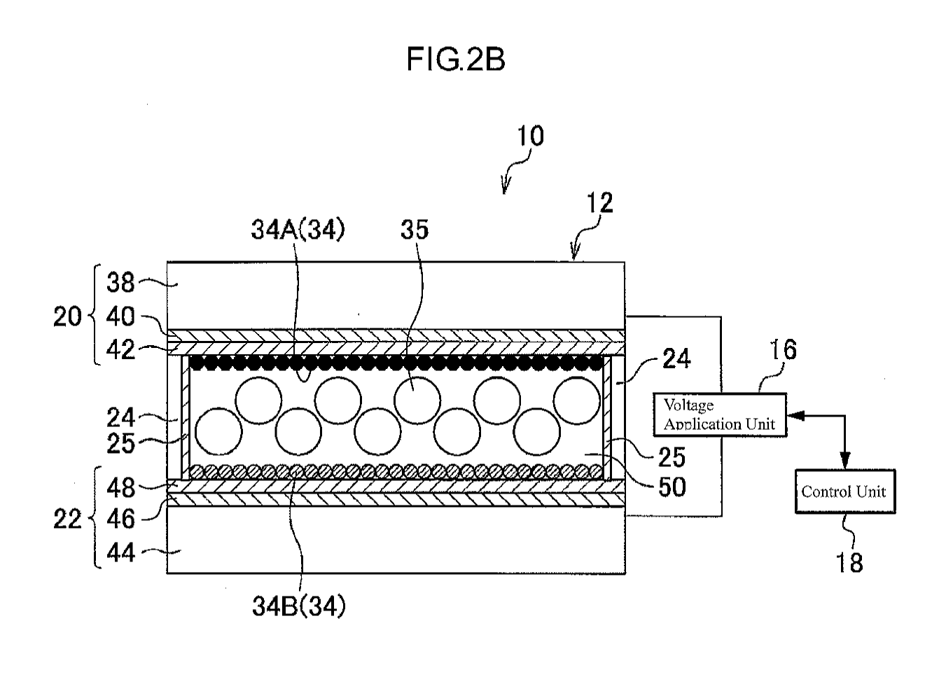

FIG. 1 is a schematic diagram illustrating a configuration of a display device according to a first exemplary embodiment. FIG. 2 schematically illustrates a moving mode of a particle group when a voltage is applied between substrates of a display medium of the display device according to the first exemplary embodiment.

A display device 10 according to the first exemplary embodiment employs a form in which a migrating particle group, excluding white particles, which migrates in accordance with the electric field is applied as a particle group 34 of a display medium 12 and a white particle group including the white display particles according to this exemplary embodiment are applied as a reflecting particle group 36.

In addition, a form in which a particle group 34A and a particle group 34B having a different color from the particle group 34A and a different charging polarity are applied as the particle group 34 is employed.

As shown in FIG. 1, the display device 10 according to this exemplary embodiment is configured to include the display medium 12, a voltage application portion 16 which applies a voltage to the display medium 12, and a control portion 18.

The display medium 12 is configured to include a display substrate 20 serving as an image display surface, a rear substrate 22 which is opposed to the display substrate 20 with a space interposed therebetween, a spacing member 24 which holds the substrates with a specific interval interposed therebetween and partitions the space between the display substrate 20 and the rear substrate 22 into a plurality of cells, and the reflecting particle group 36 which has different optical reflection characteristics from the particle group 34 included in each cell.

The above-described cell is an area surrounded by the display substrate 20, the rear substrate 22, and the spacing member 24. A dispersion medium 50 is included in the cells. The particle group 34 has a plurality of particles, is dispersed in the dispersion medium 50, and moves (migrates) between the display substrate 20 and the rear substrate 22 through spaces of the reflecting particle group 36 in accordance with the strength of an electric field formed in the cell.

By providing the spacing member 24 to correspond to each pixel for the case in which the display medium 12 displays an image, and by forming a resultant cell to correspond to each pixel, the display medium 12 may be configured to perform display on a pixel to pixel basis.

This exemplary embodiment will be described using a diagram in which attention is paid to one cell in order to simplify the description. Hereinafter, each configuration will be described in detail.

First, the pair of substrates will be described.

The display substrate 20 has a configuration in which a surface electrode 40 and a surface layer 42 are sequentially laminated on a support substrate 38. The rear substrate 22 has a configuration in which a rear electrode 46 and a surface layer 48 are laminated on a support substrate 44.

The display substrate 20, or both of the display substrate 20 and the rear substrate 22 have translucency. Here, in this exemplary embodiment, the translucency means that the transmittance of visible light is 60% or greater.

Examples of the material of the support substrate 38 and the support substrate 44 include glass and plastics such as polyethylene terephthalate resins, polycarbonate resins, acrylic resins, polyimide resins, polyester resins, epoxy resins, polyethersulfone resins, and the like.

Examples of the material of the surface electrode 40 and the rear electrode 46 include oxides of indium, tin, cadmium, antimony, and the like, complex oxides such as ITO, metals such as gold, silver, copper, and nickel, organic materials such as polypyrrole and polythiophene, and the like. The surface electrode 40 and the rear electrode 46 may be any of a single-layer film, a mixed film, or a composite film of them. The thicknesses of the surface electrode 40 and the rear electrode 46 may be, for example, from 100 Å to 2000 Å. The rear electrode 46 and the surface electrode 40 may be formed into, for example, a matrix shape or a stripe shape.

In addition, the surface electrode 40 may be embedded in the support substrate 38. In addition, the rear electrode 46 may be embedded in the support substrate 44. In this case, the material of the support substrate 38 and the support substrate 44 is selected in accordance with the composition of each particle of the particle group 34, and the like.

The rear electrode 46 and the surface electrode 40 may be separated from the display substrate 20 and the rear substrate 22, respectively, and may be disposed outside the display medium 12.

In the above description, the case has been described in which both of the display substrate 20 and the rear substrate 22 are provided with the electrode (the surface electrode 40 and the rear electrode 46). However, only one of them may be provided with the electrode to perform active matrix driving.

In addition, in order to realize the active matrix driving, the support substrate 38 and the support substrate 44 may be provided with a thin film transistor (TFT) for each pixel. The TFT may be provided in the rear substrate 22, not in the display substrate.

Next, the surface layer will be described.

The surface layer 42 and the surface layer 48 are formed on the surface electrode 40 and the rear electrode 46, respectively. Examples of the material of the surface layer 42 and the surface layer 48 include polycarbonates, polyesters, polystyrenes, polyimides, epoxys, polyisocyanates, polyamides, polyvinyl alcohols, polybutadienes, polymethyl methacrylates, copolymer nylons, ultraviolet curable acrylic resins, fluorine resins, and the like.

The surface layer 42 and the surface layer 48 may be configured to include the above-described resin and a charge transport material, or may be configured to include a self-supporting resin having a charge transport property.

Next, the spacing member will be described.

The spacing member 24 for holding the space between the display substrate 20 and the rear substrate 22 is made of, for example, a thermoplastic resin, a thermosetting resin, an electron beam curable resin, a light curing resin, rubber, metal, or the like.

The spacing member 24 may be formed integrally with any one of the display substrate 20 and the rear substrate 22. In this case, it is produced by performing an etching process of etching the support substrate 38 or the support substrate 44, a laser machining process, a press working process using a previously produced mold, a printing process, or the like.

In this case, the spacing member 24 is produced on the display substrate 20 or the rear substrate 22, or on both of them.

Although the spacing member 24 may have a color or may have no color, it is preferably transparent and has no color. In that case, the spacing member 24 is made of a transparent resin, e.g., polystyrene, polyester, or acryl.

In addition, it is also preferable that the spacing member 24 having a granular shape be transparent, whereby glass particles are also used other than a transparent resin, e.g., polystyrene, polyester, or acryl.

“Transparent” means that the transmittance of visible light is 60% or greater. Next, the particle group will be described.

It is also preferable that the particle group 34 included in the display medium 12 be dispersed in a polymeric resin as the dispersion medium 50. The polymeric resin is also preferably a polymeric gel, a polymeric polymer, or the like.

Examples of the polymeric resin include natural polymer-derived polymeric gels such as agarose, agaropectin, amylose, sodium alginate, propylene glycol alginate, isolichenan, insulin, ethyl cellulose, ethyl hydroxyethyl cellulose, curdlan, casein, carrageenan, carboxymethyl cellulose, carboxymethyl starch, callose, agar, chitin, chitosan, silk fibroin, guar gum, quince seed, Crown Gall polysaccharide, glycogen, glucomannan, keratan sulfate, keratin protein, collagen, cellulose acetate, gellan gum, schizophyllan, gelatin, ivory nut mannan, tunicin, dextran, dermatan sulfate, starch, tragacanth gum, nigeran, hyaluronic acid, hydroxyethyl cellulose, hydroxypropyl cellulose, pustulan, funoran, degraded xyloglucan, pectin, porphyran, methyl cellulose, methyl starch, laminaran, lichenan, lentinan, and locust bean gum, and almost all of polymeric gels are included in the case of a synthetic polymer.

Furthermore, polymers and the like including a functional group of alcohol, ketone, ether, ester or amide in the repeating unit are also included, such as polyvinyl alcohols, poly(meth)acrylamides, derivatives thereof, polyvinyl pyrrolidones, polyethylene oxides, and copolymers including these polymers.

Among them, gelatin, polyvinyl alcohols, poly(meth)acrylamides, and the like are preferably used from the viewpoint of manufacturing stability and electrophoretic characteristics.

These polymeric resins are preferably used as the dispersion medium 50 together with the above-described insulating liquid.

The particle group 34 included in each cell has a plurality of particles, is dispersed in the dispersion medium 50, and moves between the display substrate 20 and the rear substrate 22 in accordance with the strength of an electric field formed in the cell.

Examples of the particles of the particle group 34 include glass beads, insulating metal oxide particles such as alumina and titanium oxide, thermoplastic or thermosetting resin particles, resin particles with a coloring agent fixed to the surfaces thereof, particles of thermoplastic or thermosetting resins containing an insulating coloring agent therein, metal colloid particles having a plasmon coloring function, and the like.

Examples of the thermoplastic resin for use in the manufacturing of the particles of the particle group 34 include homopolymers or copolymers of styrenes such as styrene and chlorostyrene, mono-olefins such as ethylene, propylene, butylene and isoprene, vinyl esters such as vinyl acetate, vinyl propionate, vinyl benzoate and vinyl butyrate, α-methylene aliphatic monocarboxylates such as methyl acrylate, ethyl acrylate, butyl acrylate, dodecyl acrylate, octyl acrylate, phenyl acrylate, methyl methacrylate, ethyl methacrylate, butyl methacrylate and dodecyl methacrylate, vinyl ethers such as vinyl methyl ether, vinyl ethyl ether and vinyl butyl ether, and vinyl ketones such as vinyl methyl ketone, vinyl hexyl ketone and vinyl isopropenyl ketone.

Examples of the thermosetting resin for use in the manufacturing of the particles of the particle group 34 include crosslinked resins such as a crosslinked copolymer including divinyl benzene as a main component and crosslinked polymethyl methacrylate, phenol resins, urea resins, melamine resins, polyester resins, and silicone resins. Particularly representative binder resins include polystyrenes, styrene-alkyl acrylate copolymers, styrene-alkyl methacrylate copolymers, styrene-acrylonitrile copolymers, styrene-butadiene copolymers, styrene-maleic anhydride copolymers, polyethylenes, polypropylenes, polyesters, polyurethanes, epoxy resins, silicone resins, polyamides, modified rosins, paraffin waxes, and the like.

Organic or inorganic pigments, oil-soluble pigments, and the like can be used as the coloring agent, and known examples of the coloring agent include magnetic powders of magnetite, ferrite or the like, carbon black, titanium oxide, magnesium oxide, zinc oxide, phthalocyanine copper-based cyan color material, azo yellow color material, azo magenta color material, quinacridone-based magenta color material, red color material, green color material, blue color material, and the like. Specific representative examples thereof include aniline blue, calco oil blue, chrome yellow, ultramarine blue, DuPont oil red, quinoline yellow, methylene blue chloride, phthalocyanine blue, malachite green oxalate, lamp black, rose bengal, C.I. Pigment red 48:1, C.I. Pigment red 122, C.I. Pigment red 57:1, C.I. Pigment yellow 97, C.I. Pigment blue 15:1, C.I. Pigment blue 15:3, and the like. These may be used in combination with a plurality of color materials.

As necessary, a charge controlling agent may be mixed in the resin for the particles of the particle group 34. Known charge controlling agents for use in eletrophotographic toner materials can be used as the charge controlling agent, and examples thereof include cetylpyridinium chloride, quaternary ammonium salts such as BONTRON P-51, BONTRON P-53, BONTRON E-84, and BONTRON E-81 (all manufactured by Orient Chemical Industries, Ltd.), salicylic acid-based metal complexes, phenol-based condensates, tetraphenyl-based compounds, metal oxide particles, and metal oxide particles having a surface treated with various kinds of coupling agents.

As necessary, a magnetic material may be mixed in the particles of the particle group 34, or applied on the surfaces thereof. An organic or inorganic magnetic material that may have an optional color coating is used as the magnetic material. In addition, a transparent magnetic material, especially a transparent organic magnetic material is preferably used because it does not inhibit coloring of the color pigment and has a specific gravity which is less than that of the inorganic magnetic material.

For example, the color magnetic powder having a small particle diameter as disclosed in JP-A-2003-131420 may be used as a color magnetic powder. A color magnetic powder including core magnetic particles and a color layer laminated on the surfaces of the magnetic particles is used. The color layer may be selected so as to color the magnetic powder with a pigment or the like in an impermeable manner, but, for example, a thin light interference film is preferably used. The thin light interference film is formed by forming a thin film having a thickness equivalent to a wavelength of light using an achromatic material such as SiO₂ or TiO₂ to, and reflects light in a wavelength-selective manner due to the light interference inside the thin film.

As necessary, an external additive may be attached to the surfaces of the particles of the particle group 34. The color of the external additive is preferably transparent so as not to affect the color of the particles of the particle group 34.

Inorganic particles of metal oxides such as silicon oxide (silica), titanium oxide, and alumina are used as the external additive. These may be surface-treated with a coupling agent or silicone oil in order to adjust the charging property, fluidity, environmental dependency and the like of the particles of the particle group 34.

Examples of the coupling agent include positively charged agents such as aminosilane-based coupling agents, aminotitanium-based coupling agents, and nitrile-based coupling agents, and negatively charged agents not including a nitrogen atom (including atoms other than the nitrogen atom) such as silane-based coupling agents, titanium-based coupling agents, epoxysilane coupling agents, and acrylsilane coupling agents. In addition, examples of the silicone oil include positively charged oils such as amino-modified silicone oil, and negatively charged oils such as dimethyl silicone oil, alkyl-modified silicone oil, α-methylsulfone-modified silicone oil, methylphenyl silicone oil, chlorophenyl silicone oil, and fluorine-modified silicone oil. These are selected in accordance with the desired resistance of the external additive.

Among the above-described external additives, hydrophobic silica and hydrophobic titanium oxide that are well known are preferably used, and particularly, a titanium compound obtained by the reaction of TiO(OH)₂ with a silane compound such as a silane coupling agent, as described in JP-A-10-3177, is favorable. Any of chlorosilanes, alkoxy silanes, silazanes, and specialty silylation reagents may be used as the silane compound. The titanium compound is produced by allowing TiO(OH)₂ produced during a wet process to react with a silane compound or silicone oil, and then drying the reactant. Since this process does not include a baking process at a temperature of several hundred degrees, no strong bond is formed between the Ti atoms and no aggregation occurs. Whereby, the particles of the particle group 34 are in the form of primary particles. Furthermore, since TiO(OH)₂ is directly allowed to react with a silane compound or silicone oil, increasing the amount of the silane compound or silicone oil used for the treatment is realized, and thus charging characteristics are controlled by adjusting the amount of the silane compound or the like used for the treatment, and charging ability to be given is improved as compared with the case of conventional titanium oxide.

Generally, the volume average particle diameter of the external additive is from 5 nm to 100 nm, and preferably from 10 nm to 50 nm, but is not limited thereto.

The blending ratio of the external additive to the particles of the particle group 34 is adjusted depending on the balance of the particle diameter of the particles of the particle group 34 with the particle diameter of the external additive. When the amount of the external additive added is too large, a part of the external additive is detached from the surfaces of the particles of the particle group 34 and attached to the surfaces of the particles of other particle groups 34, whereby desired charging characteristics are not obtained. Generally, the amount of the external additive may be from 0.01 parts by mass to 3 parts by mass, and preferably from 0.05 parts by mass to 1 part by mass with respect to 100 parts by mass of the particles of the particle group 34.

The external additive may be added to the particles of any one of a plurality of kinds of particle groups 34, or may be added to two or more kinds, or all kinds of particle groups 34. When the external additive is added to the surfaces of all the particles of the particle group 34, the external additive preferably strikes the surfaces of the particles of the particle group 34 with impact power, or heating is preferably performed to strongly fix the external additive to the surfaces of the particles of the particle group 34. In this manner, detachment of the external additive from the particles of the particle group 34, strong aggregation of the external additive having an opposite polarity, and formation of a resultant aggregate of the external additive which is not easily dissociated by the electric field are prevented, thereby preventing a deterioration in image quality.

The particles of the particle group 34 will be described as having previously adjusted characteristics which contribute to the movement according to the electric field, such as an average charging quantity or an electrostatic quantity, so that the particles of the particle group 34 move between the display substrate 20 and the rear substrate 22 in accordance with the electric field formed between the substrates.

Specifically, the adjustment of the average charging quantity of the particles of the particle group 34 can be performed by adjusting the kind and amount of the charge controlling agent to be blended in the above-described resin, the kind and amount of the polymer chain to be bonded to the surfaces of the particles of the particle group 34, the kind and amount of the external additive to be added or embedded in the surfaces of the particles of the particle group 34, the kind and amount of the surfactant, polymer chain, or coupling agent to be applied to the surfaces of the particles of the particle group 34, the specific surface area of the particles of the particle group 34 (the volume average particle diameter and the shape factor), and the like.

Any well-known method may be used as the method of producing the particles of the particle group 34. For example, as described in JP-A-7-325434, a method is used which includes weighing a resin, a pigment, and a charge controlling agent at a specific mixing ratio, melting the resin by heating, adding, mixing, and dispersing the pigment, cooling the mixture, preparing the particles of the particle group 34 using a pulverizer such as a jet mill, a hammer mill, or a turbo mill, and dispersing the particles of the obtained particle group 34 in a dispersion medium. Furthermore, through a polymerization method such as suspension polymerization, emulsification polymerization or dispersion polymerization, coacervation, melt dispersion, or an emulsion aggregation method, the particles of the particle group 34 containing a charge controlling agent therein may be prepared and then dispersed in a dispersion medium to produce a dispersion medium of the particles of the particle group 34. Moreover, there is a method of using an appropriate device which disperses and kneads raw materials of the above-described resin, coloring agent, charge controlling agent, and dispersion medium at a temperature, which is lower than the point of decomposition of the resin, charge controlling agent and/or coloring agent, at which the resin can plasticize and the dispersion medium does not boil. Specifically, the particles of the particle group 34 is produced by performing heating to melt a pigment, a resin, and a charge controlling agent in a dispersion medium using a planetary mixer, a kneader or the like, cooling and stirring the melted mixture using the temperature dependency of the solvent solubility of the resin, and then allowing the mixture to coagulate/precipitate to form the particles of the particle group 34.

In addition, a method is used which includes putting the above-described raw materials into an appropriate container equipped with granular media for dispersion and kneading, such as an attritor or a heated oscillation mill such as a heated ball mill, and dispersing and kneading the content in the container at a preferable temperature range, such as from 80° C. to 160° C. Preferable examples of the granular media include steels such as stainless steel and carbon steel, alumina, zirconia, silica, and the like. When producing the particles of the particle group 34 using this method, the raw materials which have been previously made into a fluidized state are further dispersed by the granular media in the container, and then the resin including the coloring agent is allowed to precipitate from the dispersion medium by cooling the dispersion medium. The granular media maintain the state of motion during and after the cooling, and reduce the size of particles by generating shearing and/or impact.

The content of the particle group 34 (% by mass) with respect to the total mass of the content of the cell is not particularly limited as long as a concentration is achieved at which a desired color hue is obtained. It is effective for the display medium 12 to adjust the content by adjusting the thickness of the cell (i.e., the distance between the display substrate 20 and the rear substrate). That is, in order to obtain a desired color hue, the content can be reduced by increasing the thickness of the cell, and the content can be increased by reducing the thickness of the cell. Generally, the content is from 0.01% by mass to 50% by mass.

Next, the reflecting particle group will be described.

The reflecting particle group 36 has reflecting particles having different optical reflection characteristics from those of the particle group 34, and functions as a reflecting member which displays a different color from that of the particle group 34. In addition, the reflecting particle group 36 also has a function as a spacer which allows movement between the display substrate 20 and the rear substrate 22 without inhibiting the movement. That is, the particles of the particle group 34 move from the side of the rear substrate 22 to the side of the display substrate 20 or from the side of the display substrate 20 to the side of the rear substrate 22 through spaces of the reflecting particle group 36.

The white particle group of the white display particles according to this exemplary embodiment is applied as the reflecting particle group 36.

Next, other configurations of the display medium will be described.

The size of the above-described cell in the display medium 12 has a close relationship with the resolution of the display medium 12, and the smaller the cell, the higher the image resolution of the display medium 12 that can be produced. The length of the display substrate 20 of the display medium 12 in a direction of the substrate plane is typically from 10 μm to 1 mm.

In order to fix the above-described display substrate 20 and rear substrate 22 to each other with the spacing member 24 interposed therebetween, a fixing unit such as a combination of a bolt with a nut, a clamp, a clip, or a frame for fixing the substrates is used. In addition, a fixing unit such as an adhesive, thermofusion, and ultrasonic bonding may also be used.

The display medium 12 configured as described above is used in, for example, bulletin boards, circulars, electronic blackboards, advertisements, billboards, flash signals, electronic paper, electronic newspapers, and electronic books, which perform saving and rewriting of images, and document sheets for use in both copiers and printers.

Next, the display device will be described.

As described above, the display device 10 according to this exemplary embodiment is configured to include the display medium 12, the voltage application portion 16 which applies a voltage to the display medium 12, and the control portion 18 (see FIG. 1).

The voltage application portion 16 is electrically connected to the surface electrode 40 and the rear electrode 46. In this exemplary embodiment, both of the surface electrode 40 and the rear electrode 46 are described as being electrically connected to the voltage application portion 16. However, a configuration is also possible in which one of the surface electrode 40 and the rear electrode 46 is grounded while the other is electrically connected to the voltage application portion 16.

The Voltage application portion 16 is connected to the control portion 18 to send or receive a signal.

The control portion 18 may be configured as a microcomputer including a Central Processing Unit (CPU) which controls the operation of the whole device, a Random Access Memory (RAM) which temporarily stores various kinds of data, and a Read Only Memory (ROM) on which various kinds of programs such as a control program for controlling the whole device are previously stored.

The voltage application portion 16 is a voltage application device for applying a voltage to the surface electrode 40 and the rear electrode 46, and applies a voltage between the surface electrode 40 and the rear electrode 46 in accordance with the control of the control portion 18.

Next, the action of the display device 10 will be described. The action will be described in accordance with the operation of the control portion 18.

Here, a case will be described in which in the particle group 34 included in the display medium 12, the particle group 34A is negatively charged and the particle group 34B is positively charged. The description will be given on the assumption that the dispersion medium 50 is transparent and the reflecting particle group 36 is white. That is, in this exemplary embodiment, a case will be described in which the display medium 12 displays a color exhibited depending on the movement of the particle group 34A and the particle group 34B and white is displayed as the background color thereof.

First, when an initial operation signal which indicates the fact that a voltage is applied at a specified time (T1) so that the surface electrode 40 serves as a negative electrode and the rear electrode 46 serves as a positive electrode is output to the voltage application portion 16. When a negative voltage which is equal to or greater than a threshold voltage at which a variation in density ends is applied between the substrates, the particles of the particle group 34A which is negatively charged move toward and reach the rear substrate 22 (see FIG. 2(A)). On the other hand, the particles of the particle group 34B which is positively charged move toward and reach the display substrate 20 (see FIG. 2(A)).

At this time, the color exhibited by the particle group 34B is visually confirmed as the color of the display medium 12 which is visually confirmed from the side of the display substrate 20 on a white background color as the color of the reflecting particle group 36. The particle group 34A is shielded by the reflecting particle group 36 and is not easily visually confirmed.

The time T1 as information which indicates a voltage application time in the voltage application of the initial operation may be previously stored in the memory such as ROM (not shown in the drawing) in the control portion 18. When the process is executed, the information which indicates the specified time may be read.

Next, when a voltage with a polarity opposite to that of the voltage applied between the substrates is applied between the surface electrode 40 and the rear electrode 46 so that the surface electrode 40 serves as a positive electrode and the rear electrode 46 serves as a negative electrode, the negatively charged particle group 34A moves toward and reach the display substrate 20 (see FIG. 2(B)). On the other hand, the particles of the positively charged particle group 34B move toward and reach the rear surface 22 (see FIG. 2(B)).

At this time, the color exhibited by the particle group 34A is visually confirmed as the color of the display medium 12 which is visually confirmed from the side of the display substrate 20 on a white background color as the color of the reflecting particle group 36. The particle group 34B is shielded by the reflecting particle group 36 and is not easily visually confirmed.

In the display device 10 according to this exemplary embodiment, the particle group 34 (the particle group 34A and the particle group 34B) reaches and adheres to the display substrate 20 or the rear substrate 22, thereby performing display.

### Second Exemplary Embodiment

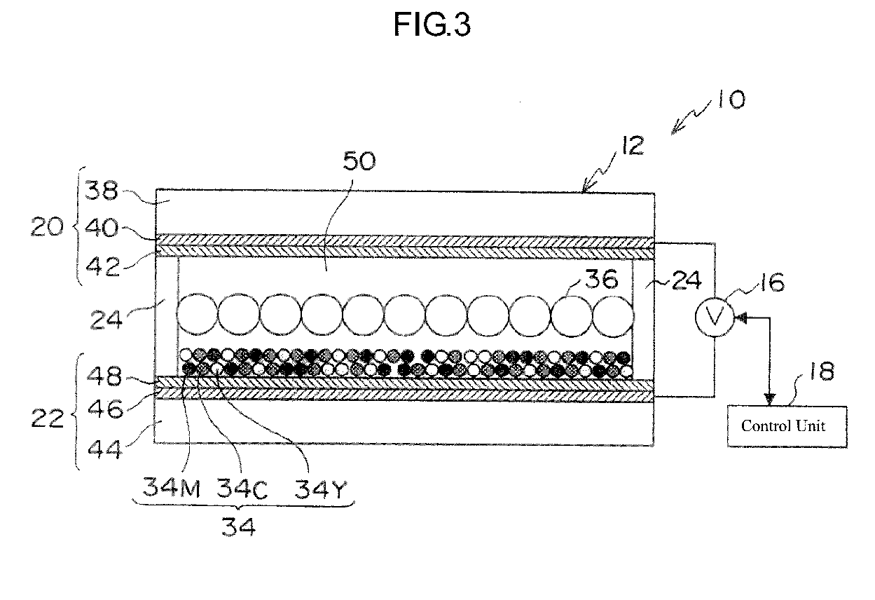

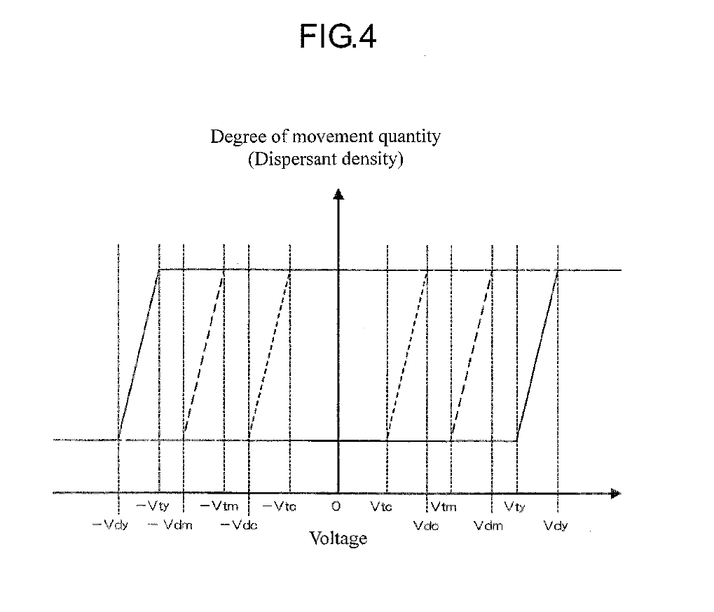

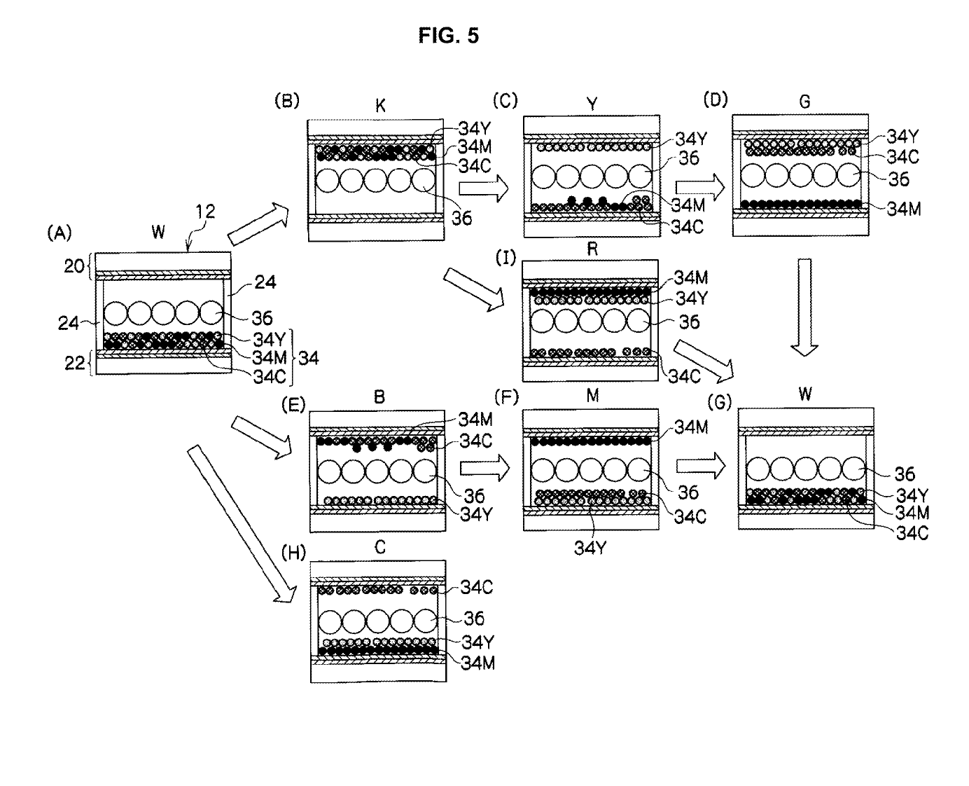

Hereinafter, a display device according to a second exemplary embodiment will be described. FIG. 3 is a schematic diagram illustrating a configuration of the display device according to the second exemplary embodiment. FIG. 4 is a diagram schematically illustrating the relationship between an applied voltage and the degree of movement (display density) of particles in the display device according to the second exemplary embodiment. FIG. 5 schematically illustrates the relationship between a mode of a voltage which is applied between substrates of a display medium and a moving mode of particles in the display device according to the second exemplary embodiment.

A display device 10 according to the second exemplary embodiment has a form in which three kinds of particle groups 34 are applied. The three kinds of particle groups 34 are charged with the same polarity.

As shown in FIG. 3, the display device 10 according to the second exemplary embodiment is configured to include a display medium 12, a voltage application portion 16 which applies a voltage to the display medium 12, and a control portion 18.

In the display device 10 according to the second exemplary embodiment, the same configurations as those of the display device 10 described in the above-described first exemplary embodiment will be denoted by the same reference numerals and detailed description thereof will be omitted.

The display medium 12 is configured to include a display substrate 20 serving as an image display surface, a rear substrate 22 which is opposed to the display substrate 20 with a space interposed therebetween, a spacing member 24 which holds the substrates with a given interval interposed therebetween and partitions the space between the display substrate 20 and the rear substrate 22 into a plurality of cells, a particle group 34 which is included in each cell, and a reflecting particle group 36 which has different optical reflection characteristics from the particle group 34.

The surfaces of the display substrate 20 and the rear substrate 22 which are opposed to each other are charged as described in the first exemplary embodiment, and a surface layer 42 and a surface layer 48 are provided on the surfaces opposed to each other, respectively.

In this exemplary embodiment, as the particle group 34, a plurality of kinds of particle groups 34 having different colors from each other are dispersed in a dispersion medium 50.

In this exemplary embodiment, although the description will be given on the assumption that the particle groups 34 having different colors from each other, i.e., a yellow particle group 34Y having a yellow color, a magenta particle group 34M having a magenta color, and a cyan particle group 34C having a cyan color are dispersed as the three kinds of particle groups 34, the number of the kinds of the particle groups 34 is not limited to three.

The plurality kinds of particle groups 34 are particle groups which electrophoretically migrate between the substrates, and the particle groups having different colors are different from each other in terms of the absolute value of the voltage necessary for movement in accordance with the electric field. That is, the respective particle groups 34 having different colors (the yellow particle group 34Y, the magenta particle group 34M, and the cyan particle group 34C) have a voltage range necessary for moving the respective particle groups 34 having different colors, and the voltage ranges are different from each other.

The respective particles of the plurality kinds of particle groups 34 which are different from each other in terms of the absolute value of the voltage necessary for movement in accordance with the electric field are obtained by: producing particle dispersion liquids which include particles having different charging quantities by changing the kind and concentration of the resin constituting the particles, the amount of the charge controlling agent, and the like; and mixing them.

Here, as described above, the yellow particle group 34Y, the magenta particle group 34M, and the cyan particle group 34C having different colors from each other are dispersed as the three kinds of particle groups 34 in the display medium 12 according to this exemplary embodiment, and in the plurality kinds of particle groups 34, the absolute value of the voltage necessary for movement in accordance with the electric field is varied between the particle groups having the different colors.

In this exemplary embodiment, regarding the absolute values of the voltages at which the respective particle groups of three colors, i.e., the magenta particle group 34M having a magenta color, the cyan particle group 34C having a cyan color, and the yellow particle group 34Y having a yellow color start to move, the absolute value of the voltage at which the magenta particle group 34M having a magenta color start to move will be denoted by |Vtm|, the absolute value of the voltage at which the cyan particle group 34C having a cyan color start to move will be denoted by |Vtc|, and the absolute value of the voltage at which the yellow particle group 34Y having a yellow color starts to move will be denoted by |Vty| in the description. Moreover, regarding the absolute value of the maximum voltage for moving all the particle groups of three colors, i.e., the magenta particle group 34M having a magenta color, the cyan particle group 34C having a cyan color, and the yellow particle group 34Y having a yellow color in the particle groups 34 having different colors, the absolute value of the maximum voltage for moving the magenta particle group 34M having a magenta color will be denoted by |Vdm|, the absolute value of the maximum voltage for moving the cyan particle group 34C having a cyan color will be denoted by |Vdc|, and the absolute value of the maximum voltage for moving the yellow particle group 34Y having a yellow color will be denoted by |Vdy| in the description.

In the following description, absolute values of Vtc, −Vtc, Vdc, −Vdc, Vtm, −Vtm, Vdm, −Vdm, Vty, −Vty, Vdy, and −Vdy satisfy the relationship, i.e., |Vtc|<|Vdc|<|Vtm|<|Vdm|<|Vty|<|Vdy|.

Specifically, as shown in FIG. 4, the three kinds of particle groups 34 are, for example, dispersed in the dispersion medium 50 in a state of being charged with the same polarity, and an absolute value |Vtc≦Vc≦Vdc| of a voltage range necessary for moving the cyan particle group 34C (an absolute value having a value of from Vtc to Vdc), an absolute value |Vtm≦Vm≦Vdm| of a voltage range necessary for moving the magenta particle group 34M (an absolute value having a value of from Vtm to Vdm), and an absolute value |Vty≦Vy≦Vdy| of a voltage range necessary for moving the yellow particle group 34Y (an absolute value having a value of from Vty to Vdy) are set to be increases without overlap therebetween in this order.

In order to independently drive the respective particle groups 34 having different colors, the absolute value |Vdc| of the maximum voltage for moving all the particles of the cyan particle group 34C is set to be smaller than the absolute value |Vtm≦Vm≦Vdm| of a voltage range necessary for moving the magenta particle group 34M (the absolute value having a value of from Vtm to Vdm) and the absolute value |Vty≦Vy≦Vdy| of a voltage range necessary for moving the yellow particle group 34Y (the absolute value having a value of from Vty to Vdy). In addition, the absolute value |Vdm| of the maximum voltage for moving all the particles of the magenta particle group 34M is set to be smaller than the absolute value |Vty≦Vy≦Vdy| of a voltage range necessary for moving the yellow particle group 34Y (the absolute value having a value of from Vty to Vdy).

That is, in this exemplary embodiment, the particle groups 34 having different colors are independently driven by setting the voltage ranges necessary for moving the respective particle groups 34 having different colors without overlap therebetween.

“Voltage range necessary for moving the particle group 34” is a voltage range in which there is no variation in display density and the display density is saturated even when the voltage and the voltage application time are increased from the voltage necessary for starting the movement of the particles and from when the movement starts.

In addition, “maximum voltage necessary for moving all the particle groups 34” is a voltage at which there is no variation in display density and the display density is saturated even when the voltage and the voltage application time are increased from when the above-described movement starts.

In addition, “all” includes a meaning that the characteristics of a part of the particle group 34 are different so as not to contribute to the display characteristics, because there is a variation in characteristics of the particle groups 34 having different colors. That is, there is no variation in display density and the display density is saturated even when the voltage and the voltage application time are increased from when the above-described movement starts.

In addition, “display density” is a density at which there is no variation in density and the density is saturated even when while the color density on the display surface side is measured as an optical density (OD) using a reflection densitometer, manufactured by X-rite, a voltage is applied between the display surface side and the rear surface side and is gradually changed in a direction in which the measured density increases (the applied voltage is increased or reduced), whereby the variation in density per unit voltage is saturated, and in that state, the voltage and the voltage application time are increased.

In the display medium 12 according to this exemplary embodiment, when a voltage is applied between the display substrate 20 and the rear substrate 22 from 0 V and exceeds +Vtc by gradually increasing the voltage value of the applied voltage, the display density starts to vary due to the movement of the cyan particle group 34C in the display medium 12. Furthermore, when the voltage applied between the substrates is further increased to +Vdc by increasing the voltage value, the variation in display density due to the movement of the cyan particle group 34C stops in the display medium 12.

When the voltage applied between the display substrate 20 and the rear substrate 22 exceeds +Vtm by increasing the voltage value, the display density starts to vary due to the movement of the magenta particle group 34M in the display medium 12. When the voltage applied between the display substrate 20 and the rear substrate 22 reaches +Vdm by increasing the voltage value, the variation in display density due to the movement of the magenta particle group 34M stops in the display medium 12.

When the voltage applied between the substrates exceeds +Vty by increasing the voltage value, the display density starts to vary due to the movement of the yellow particle group 34Y in the display medium 12. When the voltage applied between the substrates reaches +Vdy by increasing the voltage value, the variation in display density due to the movement of the yellow particle group 34Y stops in the display medium 12.

In contrast, when a negative electrode voltage is applied between the display substrate 20 and the rear substrate 22 from 0 V and the absolute value thereof is gradually increased to exceed the absolute value of the voltage −Vtc applied between the substrates, the display density starts to vary due to the movement of the cyan particle group 34C between the substrates in the display medium 12. When the absolute value of the voltage value is increased and thus the voltage applied between the display substrate 20 and the rear substrate 22 is −Vdc or higher, the variation in display density due to the movement of the cyan particle group 34C stops in the display medium 12.

When a negative electrode voltage is applied by increasing the absolute value of the voltage value and the voltage applied between the display substrate 20 and the rear substrate 22 exceeds the absolute value of −Vtm, the display density starts to vary due to the movement of the magenta particle group 34M in the display medium 12. When the absolute value of the voltage value is increased and thus the voltage applied between the display substrate 20 and the rear substrate 22 reaches −Vdm, the variation in display density due to the movement of the magenta particle group 34M stops in the display medium 12.

Furthermore, when a negative electrode voltage is applied by increasing the absolute value of the voltage value and the voltage applied between the display substrate 20 and the rear substrate 22 exceeds the absolute value of −Vty, the display density starts to vary due to the movement of the yellow particle group 34Y in the display medium 12. When the absolute value of the voltage value is increased and thus the voltage applied between the substrates reaches −Vdy, the variation in display density due to the movement of the yellow particle group 34Y stops in the display medium 12.

That is, in this exemplary embodiment, when a voltage within the range of from −Vtc to +Vtc (voltage range of |Vtc| or lower) is applied between the display substrate 20 and the rear substrate 22, it is considered that the particles of the particle groups 34 (the cyan particle group 34C, the magenta particle group 34M, and the yellow particle group 34Y) do not move to such a degree as to vary the display density of the display medium 12 as shown in FIG. 4. When a voltage having an absolute value higher than the absolute value of the voltage +Vtc and the voltage −Vtc is applied between the substrates, the particles of the cyan particle group 34C in the particle groups 34 of three colors start to move to such a degree as to vary the display density of the display medium 12, so that the display density starts to vary. When a voltage having an absolute value equal to or higher than the absolute value |Vdc| of the voltage −Vdc and the voltage Vdc is applied, there occurs no variation in display density per unit voltage.

Furthermore, when a voltage within the range of from −Vtm to +Vtm (voltage range of |Vtm| or lower) is applied between the display substrate 20 and the rear substrate 22, it is considered that the particles of the magenta particle group 34M and the yellow particle group 34Y do not move to such a degree as to vary the display density of the display medium 12. When a voltage having an absolute value higher than the absolute value of the voltage +Vtm and the voltage −Vtm is applied between the substrates, the magenta particle group 34M and the magenta particle group 34M in the yellow particle group 34Y start to move to such a degree as to vary the display density of the display medium 12, so that the display density per unit voltage starts to vary. When a voltage having an absolute value equal to or higher than the absolute value |Vdm| of the voltage −Vdm and the voltage Vdm is applied, there occurs no variation in display density.

Furthermore, when a voltage within the range of from −Vty to +Vty (voltage range of |Vty| or lower) is applied between the display substrate 20 and the rear substrate 22, it is considered that the particles of the yellow particle group 34Y do not move to such a degree as to vary the display density of the display medium 12. When a voltage having an absolute value higher than the absolute value of the voltage +Vty and the voltage −Vty is applied between the substrates, the particles of the yellow particle group 34Y start to move to such a degree as to vary the display density of the display medium 12, so that the display density starts to vary. When a voltage having an absolute value equal to or higher than the absolute value |Vdy| of the voltage −Vdy and the voltage Vdy is applied, there occurs no variation in display density.

Next, the mechanism of the particle movement when the display medium 12 displays an image will be described with reference to FIG. 5.

For example, the description will be given on the assumption that the yellow particle group 34Y, the magenta particle group 34M, and the cyan particle group 34C are included as the plurality of kinds of particle groups 34 in the display medium 12.

In addition, in the following description, a voltage to be applied between the substrates which is higher than the voltage necessary for starting the movement of the particles of the yellow particle group 34Y in terms of the absolute value but is equal to or lower than the above-described maximum voltage for the yellow particle group 34Y is referred to as “large voltage”, a voltage to be applied between the substrates which is higher than the voltage necessary for starting the movement of the particles of the magenta particle group 34M in terms of the absolute value but is equal to or lower than the above-described maximum voltage for the magenta particle group 34M is referred to as “medium voltage”, and a voltage to be applied between the substrates which is higher than the voltage necessary for starting the movement of the particles of the cyan particle group 34C in terms of the absolute value but is equal to or lower than the above-described maximum voltage for the magenta particle group 34C is referred to as “small voltage”.

In addition, when a voltage is applied between the substrates so that the voltage on the side of the display substrate 20 is higher than that on the side of the rear substrate 22, the respective voltages are referred to as “+large voltage”, “+medium voltage”, and “+small voltage”, respectively. In addition, when a voltage is applied between the substrates so that the voltage on the side of the rear substrate 22 is higher than that on the side of the display substrate 20, the respective voltages are referred to as “−large voltage”, “−medium voltage”, and “−small voltage”, respectively.

As shown in FIG. 5(A), on the assumption that the magenta particle group 34M, the cyan particle group 34C, and the yellow particle group 34Y as all the particle groups are positioned on the side of the rear substrate 22 in an initial state (white display state), when a “+large voltage” is applied between the display substrate 20 and the rear substrate 22 in the initial state, the magenta particle group 34M, the cyan particle group 34C, and the yellow particle group 34Y as all the particle groups move toward the display substrate 20. Even when the application of voltage is stopped in this state, the respective particle groups remain attached to the display substrate 20 and do not move, so that display of black continues due to subtractive color mixing of the magenta particle group 34M, the cyan particle group 34C, and the yellow particle group 34Y (subtractive color mixing of magenta, cyan, and yellow) (see FIG. 5(B)).

Next, when a “−medium voltage” is applied between the display substrate 20 and the rear substrate 22 in the state shown in FIG. 5(B), the magenta particle group 34M and the cyan particle group 34C in the particle groups 34 of all the colors move toward the rear substrate 22. Therefore, only the yellow particle group 34Y remains attached to the display substrate 20, so that yellow is displayed (see FIG. 5(C)).

Furthermore, when a “+small voltage” is applied between the display substrate 20 and the rear substrate 22 in the state shown in FIG. 5(C), the cyan particle group 34C in the magenta particle group 34M and the cyan particle group 34C which have moved toward the rear substrate 22 moves toward the display substrate 20. Therefore, the yellow particle group 34Y and the cyan particle group 34C are attached to the display substrate 20, so that green is displayed due to subtractive color mixing of yellow and cyan (see FIG. 5(D)).

In addition, when a “−small voltage” is applied between the display substrate 20 and the rear substrate 22 in the state shown in FIG. 5(B), the cyan particle group 34C in all the particle groups 34 moves toward the rear substrate 22. Therefore, the yellow particle group 34Y and the magenta particle group 34M are attached to the display substrate 20, so that red is displayed due to subtractive color mixing of yellow and magenta (see FIG. 5(I)).

When a “+medium voltage” is applied between the display substrate 20 and the rear substrate 22 in the initial state shown in FIG. 5(A), the magenta particle group 34M and the cyan particle group 34C in all the particle groups 34 (the magenta particle group 34M, the cyan particle group 34C, and the yellow particle group 34Y) move toward the display substrate 20. Therefore, the magenta particle group 34M and the cyan particle group 34C are attached to the display substrate 20, so that blue is displayed due to subtractive color mixing of magenta and cyan (see FIG. 5(E)).

When a “−small voltage” is applied between the display substrate 20 and the rear substrate 22 in the state shown in FIG. 5(E), the cyan particle group 34C in the magenta particle group 34M and the cyan particle group 34C attached to the display substrate 20 move toward the rear substrate 22.

Therefore, only the magenta particle group 34M is attached to the display substrate 20, so that magenta is displayed (see FIG. 5(F)).

When a “−large voltage” is applied between the display substrate 20 and the rear substrate 22 in the state shown in FIG. 5(F), the magenta particle group 34M attached to the display substrate 20 moves toward the rear substrate 22.

Therefore, nothing is attached to the display substrate 20, so that white, which is the color of the reflecting particle group 36, is displayed (see FIG. 5(G)).

When a “+small voltage” is applied between the display substrate 20 and the rear substrate 22 in the initial state shown in FIG. 5(A), the cyan particle group 34C in all the particle groups 34 (the magenta particle group 34M, the cyan particle group 34C, and the yellow particle group 34Y) moves toward the display substrate 20. Therefore, the cyan particle group 34C is attached to the display substrate 20, so that cyan is displayed (see FIG. 5(H)).

When a “−large voltage” is applied between the display substrate 20 and the rear substrate 22 in the state shown in FIG. 5(I), all the particle groups 34 move toward the rear substrate 22 as shown in FIG. 5(G), and thus white is displayed.

In addition, when a “−large voltage” is applied between the display substrate 20 and the rear substrate 22 in the state shown in FIG. 5(D), all the particle groups 34 move toward the rear substrate 22 as shown in FIG. 5(G), and thus white is displayed.

In this exemplary embodiment, since a voltage specified for the respective particle groups 34 is applied and desired particles are thus selectively moved in accordance with the electric field caused by the voltage, particles having colors other than the desired color are suppressed from moving in the dispersion medium 50, color mixing in which colors other than the desired color are mixed is suppressed, and color display is performed while suppressing a deterioration in image quality of the display medium 12.

As long as the absolute values of the voltages necessary for moving the respective particle groups 34 in accordance with the electric field are different from each other, clear color display is realized even when the voltage ranges necessary for movement in accordance with the electric field overlap each other. When the voltage ranges are different from each other, color display is realized while further suppressing color mixing.

In addition, by dispersing the particle groups 34 of three colors, i.e., cyan, magenta, and yellow in the dispersion medium 50, cyan, magenta, yellow, blue, red, green, and black are displayed, and white is displayed by, for example, the reflecting particle group 36 having a white color. Moreover, display of a particular color is realized.

The form has been described in which in the display medium 12 and the display device 10 according to any of the above-described exemplary embodiments, the surface electrode 40 is provided in the surface substrate 20 and the rear electrode 46 is provided in the rear substrate 22 to apply a voltage between the electrodes (i.e., between the substrates) to thereby move (migrate) the particle group 34 between the substrates, thereby performing display. However, the invention is not limited thereto, and a form may also be employed in which the surface electrode 40 is provided in the display substrate 20 and an electrode is provided in the spacing member to apply a voltage between the electrodes to thereby move the particle group 34 between the display substrate 20 and the spacing member, thereby performing display.

The form has been described in which in the display medium 12 and the display device 10 according to any of the above-described exemplary embodiments, the surface electrode 40 is provided in the display substrate 20 and the rear electrode 46 is provided in the rear substrate 22, thereby configuring the display medium 12. However, a form may also be employed in which the respective electrodes are disposed outside the display medium 12.

In addition, the form has been described in which in the display medium 12 and the display device 10 according to any of the above-described exemplary embodiments, two or three kinds (two or three colors) of particle groups (34A, 34B) are applied as the particle group 34. However, a form may also be employed in which one kind (one color) of particle group is applied, or more than four kinds (four colors) of particle groups are applied.

### EXAMPLES

Hereinafter, the invention will be described in more detail with reference to examples, but is not limited to the examples.

Hereinafter, “part” is based on mass, unless otherwise noted.

### Examples 1 to 44

### Comparative Examples 1 to 9

### Producing of Display Particles According to First Exemplary Embodiment

Raw material components of a copolymer having a composition ratio (parts by mass) described in Table 1, 2, 3, 4, or 5, 1 part of lauroyl peroxide (manufactured by Aldrich) as a polymerization initiator, and 100 parts of toluene are mixed. The resultant mixture is heated for 6 hours at 75° C. and then dripped in isopropyl alcohol, thereby obtaining a copolymer which is a white precipitate.

The weight average molecular weight of each copolymer is measured using gel permeation chromatography (GPC).

20 parts of the copolymer obtained as described above and 100 parts of toluene are mixed to dissolve the copolymer. In the obtained solution, 200 parts of dimethyl silicone oil (manufactured by Shin-Etsu Chemical Co., Ltd., KF-96L-2cs) is dripped to precipitate the copolymer. Thereafter, the toluene is removed using an evaporator at 60° C. with a degree of vacuum of 20 mbar, thereby obtaining a white particle dispersion liquid in which the particles constituted of the above-described copolymer are dispersed in the silicone oil.

The volume average particle diameter of each white particle is measured using a particle diameter analyzer (FPAR-1000, manufactured by Otsuka Electronics Co., Ltd.).

### Examples 101 to 103

### Comparative Example 101

### Producing of Display Particles According to Second Exemplary Embodiment

Raw material components of a copolymer having a composition ratio (parts by mass) described in Table 6, 1 part of lauroyl peroxide (manufactured by Aldrich) as a polymerization initiator, and 100 parts of toluene are mixed. The resultant mixture is heated for 6 hours at 75° C. and then dripped in isopropyl alcohol, thereby obtaining a copolymer which is a white precipitate.

20 parts of the copolymer obtained as described above and 100 parts of toluene are mixed to dissolve the copolymer, and then 10 parts of titanium oxide (TTO-55A, manufactured by Ishihara Sangyo Kaisha, Ltd.) is added thereto and the mixture is dispersed for 1 hour in a rocking mill using zirconia beads (having a diameter of 1 μm). In the dispersion liquid after removal of the zirconia beads, 200 parts of dimethyl silicone oil (manufactured by Shin-Etsu Chemical Co., Ltd., KF-96L-2cs) is dripped to precipitate the copolymer. Thereafter, the toluene is removed using an evaporator at 60° C. with a degree of vacuum of 20 mbar, thereby obtaining a white particle dispersion liquid in which the titanium oxide particles coated with the resin are dispersed in the silicone oil.

The volume average particle diameter of each white particle is measured using a particle diameter analyzer (FPAR-1000, manufactured by Otsuka Electronics Co., Ltd.).

Evaluation

The white particle dispersion liquids of Examples 1 to 44, Comparative Examples 1 to 9, Examples 101 to 103, and Comparative Example 101 are evaluated as follows. The results are shown in the following Tables 1 to 6.

Charge Quantity

Producing of Display Medium Cell 1 for Evaluation

A glass substrate with an indium tin oxide (ITO) film as an electrode having a thickness of 50 nm formed using a sputtering method is spin-coated with a solution of a fluorine resin (manufactured by Asahi Glass Co., Ltd., Cytop), and it is dried for 1 hour at 130° C., thereby forming a surface layer having a thickness of 80 nm.

Two ITO substrates with a surface layer obtained in this manner are prepared as a display substrate and a rear substrate. The surface layers are allowed to be opposed to each other with a 50 μm-Teflon (registered trademark) sheet as a spacer (spacing member) interposed therebetween so that the display substrate overlap the rear substrate, and these are fixed using a clip.

A white particle dispersion liquid prepared to have a solid content of white particles of 20% by mass is injected into the space between the two ITO substrates with a surface layer, thereby obtaining a display medium cell 1 for evaluation.

Measurement of Charge Quantity

The display medium cell 1 for evaluation is used and a potential difference of 15 V is applied for 5 seconds between the electrodes so that the surface electrode becomes a negative electrode. The charge quantity flowing at this time is measured using an ammeter (manufactured by Keithley Instruments, Electrometer 6514). The charge quantity just after the application of the voltage is subtracted from the charge quantity after termination of the migration of all the particles to calculate the charge quantity of the particles. Here, the charge quantity is calculated as a total charge quantity (nC/cm²) per unit display area.

Mixed-Color Display

Producing of Display Medium Cell 2 for Evaluation

A mixed dispersion liquid is obtained by mixing the following cyan particle dispersion liquid and white particle dispersion liquid. At this time, the solid content of cyan particles is adjusted to 1.5% by mass, and the solid content of white particles is adjusted to achieve a degree of whiteness of 30% for Examples 1 to 44 and Comparative Examples 1 to 9, and 50% for Examples 101 to 103 and Comparative Example 101.

A display medium cell 2 for evaluation is obtained by including the mixed dispersion liquid between a pair of glass substrates each having an ITO electrode formed therein (in a cell in which a 50 μm-spacer is interposed between two ITO substrates with a surface layer).

Cyan Particle Dispersion Liquid

65 parts of 2-hydroxyethyl methacrylate, 30 parts of a silicone macromer (manufactured by Chisso Corporation, SILAPLANE: FM-0721), and 5 parts of methacrylic acid are mixed with 100 parts of isopropyl alcohol and azobisisobutyronitrile (polymerization initiator, manufactured by Aldrich, AIBN) is dissolved therein to perform polymerization for 6 hours at 70° C. under a nitrogen atmosphere. The resultant product is refined and dried to obtain a polymer.

Next, 0.5 g of the polymer is added to and dissolved in 9 g of isopropyl alcohol, and then 0.5 g of a cyan pigment (manufactured by Sanyo Color Works, Ltd., Cyanine Blue-4973) is added thereto and the mixture is dispersed for 48 hours using zirconia balls of 0.5 mmφ, thereby obtaining a pigment-containing polymeric solution.

3 g of the pigment-containing polymeric solution is taken, and while applying an ultrasonic wave thereto, 12 g of dimethyl silicone oil (manufactured by Shin-Etsu Chemical Co., Ltd., KF-96L-2cs) is dripped little by little to perform emulsification. Thereafter, the isopropyl alcohol is removed by heating at 60° C. and depressurization using an evaporator, thereby obtaining migrating particles including the polymer and the pigment. Next, the particles are settled using a centrifuge to remove the supernatant liquid, 5 g of the above-described silicone oil is added thereto and an ultrasonic wave is applied to perform washing. Thereafter, the particles are settled using the centrifuge to remove the supernatant liquid and 5 g of the above-described silicone oil is added thereto, thereby obtaining a cyan particle dispersion liquid. The volume average particle diameter of the obtained cyan particles is 0.2 μm.

The dispersion liquid is included between two electrode substrates and a DC voltage is applied thereto to observe the migration direction in order to evaluate the charging polarity of the particles in the cyan particle dispersion liquid. It is evaluated that the particles are negatively charged.

Evaluation Method

The display medium cell 2 for evaluation is used and a DC of a voltage of 10 V is applied between the electrodes (between the electrodes thereof) to move the cyan particles by positive/negative switching. When a positive voltage is applied to the electrode of the display substrate, the cyan particles move toward the display substrate and cyan is displayed. On the other hand, when a negative voltage is applied to the electrode of the display substrate, the cyan particles move toward the rear substrate and white is displayed. A positive voltage is applied to the electrode of the display substrate, and the cyan density on the display substrate which displays the cyan is measured using a colorimeter X-Rite 404 (manufactured by X-Rite). The degree (%) of deterioration in cyan density is obtained based on the cyan density when the cell including only the cyan particles is measured on a reflecting plate of a degree of whiteness of 30% or 50%, and evaluation is performed in accordance with the following evaluation standards.
A: Less Than 10% in Deterioration in Cyan Density
B: From 10% to Less Than 20% in Deterioration in Cyan Density
C: From 20% to Less Than 40% in Deterioration in Cyan Density
D: 40% or Greater in Deterioration in Cyan Density

TABLE 1

| | Raw Material Components of Copolymer (parts by mass) | | | | | | | Weight | Volume | | |
|---|---|---|---|---|---|---|---|---|---|---|---|
| | | | | | Acid Group-Containing | | | Average | Average | Total | |
| | | | | | Polymerization | | Silicone | Molecular | Particle | Charge | Mixed- |
| | Specific Vinyl Compound | | | | Component | | Macromer | Weight of | Diameter of | Quantity | Color |
| | St | VNp | VBP | DVB | MAA | CB-1 | FM0721 | Copolymer | Particles [μm] | [nC/cm²] | Display |
| Example 1 | 74.5 | — | — | — | 0.5 | — | 25 | 35000 | 0.27 | 0.42 | A |
| Example 2 | 70 | — | — | — | 5 | — | 25 | 30000 | 0.28 | 0.35 | A |
| Example 3 | 65 | — | — | — | 10 | — | 25 | 32000 | 0.24 | 0.32 | A |
| Example 4 | 55 | — | — | — | 20 | — | 25 | 34000 | 0.29 | 0.28 | A |
| Example 5 | — | 54.5 | — | — | 0.5 | — | 45 | 31000 | 0.24 | 0.50 | A |
| Example 6 | — | 50 | — | — | 5 | — | 45 | 32000 | 0.27 | 0.32 | A |
| Example 7 | — | 45 | — | — | 10 | — | 45 | 34000 | 0.25 | 0.30 | A |
| Example 8 | — | 35 | — | — | 20 | — | 45 | 31000 | 0.25 | 0.22 | A |
| Example 9 | — | — | 54.5 | — | 0.5 | — | 45 | 34000 | 0.26 | 0.40 | A |
| Example 10 | — | — | 50 | — | 5 | — | 45 | 32000 | 0.24 | 0.32 | A |
| Example 11 | — | — | 45 | — | 10 | — | 45 | 33000 | 0.24 | 0.28 | A |
| Example 12 | — | — | 35 | — | 20 | — | 45 | 35000 | 0.27 | 0.25 | A |
| Example 13 | 74 | — | — | 0.5 | 0.5 | — | 25 | 55000 | 0.25 | 0.38 | A |
| Example 14 | 69.5 | — | — | 0.5 | 5 | — | 25 | 52000 | 0.21 | 0.30 | A |
| Example 15 | 64.5 | — | — | 0.5 | 10 | — | 25 | 52000 | 0.25 | 0.27 | A |
| Example 16 | 54.5 | — | — | 0.5 | 20 | — | 25 | 50000 | 0.28 | 0.20 | A |
| Example 17 | 74.5 | — | — | — | — | 0.5 | 25 | 28000 | 0.25 | 0.44 | A |
| Example 18 | 70 | — | — | — | — | 5 | 25 | 29000 | 0.21 | 0.32 | A |
| Example 19 | 65 | — | — | — | — | 10 | 25 | 31000 | 0.26 | 0.30 | A |
| Example 20 | 55 | — | — | — | — | 20 | 25 | 30000 | 0.22 | 0.21 | A |

TABLE 2

| | Raw Material Components of Copolymer (parts by mass) | | | | | Weight Average | | Total | |
|---|---|---|---|---|---|---|---|---|---|
| | Specific Vinyl | | | Neutral Group-Containing | Silicone | Molecular | Volume Average | Charge | Mixed- |
| | Compound | | | Polymerization Component | Macromer | Weight of | Particle Diameter of | Quantity | Color |
| | St | VNp | VBP | HEMA | FM0721 | Copolymer | Particles [μm] | [nC/cm²] | Display |
| Example 21 | 74.5 | — | — | 0.5 | 25 | 35000 | 0.24 | 0.65 | A |
| Example 22 | 70 | — | — | 5 | 25 | 30000 | 0.23 | 0.62 | A |
| Example 23 | 65 | — | — | 10 | 25 | 31000 | 0.25 | 0.52 | A |
| Example 24 | 55 | — | — | 20 | 25 | 30000 | 0.26 | 0.44 | A |
| Example 25 | — | 54.5 | — | 0.5 | 45 | 31000 | 0.26 | 0.60 | A |
| Example 26 | — | 50 | — | 5 | 45 | 29000 | 0.24 | 0.50 | A |
| Example 27 | — | 45 | — | 10 | 45 | 32000 | 0.25 | 0.45 | A |
| Example 28 | — | 35 | — | 20 | 45 | 33000 | 0.27 | 0.40 | A |
| Example 29 | — | — | 54.5 | 0.5 | 45 | 29000 | 0.26 | 0.55 | A |
| Example 30 | — | — | 50 | 5 | 45 | 27000 | 0.28 | 0.47 | A |
| Example 31 | — | — | 45 | 10 | 45 | 28000 | 0.29 | 0.40 | A |
| Example 32 | — | — | 35 | 20 | 45 | 27000 | 0.26 | 0.30 | A |

TABLE 3

| | Raw Material Components of Copolymer (parts by mass) | | | | | | | | |
|---|---|---|---|---|---|---|---|---|---|
| | Specific Vinyl | | | Basic Group-Containing | Silicone | Weight Average | Volume Average | Total Charge | Mixed- |
| | Compound | | | Polymerization Component | Macromer | Molecular Weight | Particle Diameter | Quantity | Color |
| | St | VNp | VBP | DEAEMA | FM0721 | of Copolymer | of Particles [μm] | [nC/cm²] | Display |
| Example 33 | 74.5 | — | — | 0.5 | 25 | 32000 | 0.23 | 0.62 | A |
| Example 34 | 70 | — | — | 5 | 25 | 30000 | 0.22 | 0.52 | A |
| Example 35 | 65 | — | — | 10 | 25 | 32000 | 0.26 | 0.48 | A |
| Example 36 | 55 | — | — | 20 | 25 | 34000 | 0.24 | 0.42 | A |
| Example 37 | — | 54.5 | — | 0.5 | 45 | 28000 | 0.24 | 0.66 | A |
| Example 38 | — | 50 | — | 5 | 45 | 28000 | 0.25 | 0.52 | A |
| Example 39 | — | 45 | — | 10 | 45 | 29000 | 0.26 | 0.45 | A |
| Example 40 | — | 35 | — | 20 | 45 | 31000 | 0.25 | 0.40 | A |
| Example 41 | — | — | 54.5 | 0.5 | 45 | 27000 | 0.28 | 0.58 | A |
| Example 42 | — | — | 50 | 5 | 45 | 26000 | 0.26 | 0.45 | A |
| Example 43 | — | — | 45 | 10 | 45 | 28000 | 0.25 | 0.38 | A |
| Example 44 | — | — | 35 | 20 | 45 | 28000 | 0.27 | 0.35 | A |

TABLE 4

| | Raw Material Components | | | | | | | | |
|---|---|---|---|---|---|---|---|---|---|
| | of Copolymer (parts by mass) | | | | | | | | |
| | Specific Vinyl | | | | Silicone | Weight Average | Volume Average | Total Charge | |
| | Compound | | | | Macromer | Molecular Weight | Particle Diameter of | Quantity | Mixed-Color |
| | St | VNp | VBP | DVB | FM0721 | of Copolymer | Particles [μm] | [nC/cm²] | Display |
| Comparative | 75 | — | — | — | 25 | 30000 | 0.22 | 1.50 | B |
| Example 1 | | | | | | | | | |
| Comparative | — | 55 | — | — | 45 | 28000 | 0.23 | 1.12 | B |
| Example 2 | | | | | | | | | |
| Comparative | — | — | 55 | — | 45 | 27000 | 0.23 | 1.05 | B |
| Example 3 | | | | | | | | | |
| Comparative | 74.5 | — | — | 0.5 | 25 | 50000 | 0.28 | 1.32 | B |
| Example 4 | | | | | | | | | |

TABLE 5

| | Raw Material Components of Copolymer | | | | | | |
|---|---|---|---|---|---|---|---|
| | (parts by mass) | | | | | | |
| | | Acid Group-Containing | Silicone | Weight Average | Volume Average | Total Charge | |
| | | Polymerization Component | Macromer | Molecular Weight | Particle Diameter of | Quantity | Mixed-Color |
| | MMA | MAA | FM0721 | of Copolymer | Particles [μm] | [nC/cm²] | Display |
| Comparative | 75 | — | 25 | 38000 | 0.28 | 2.45 | C |
| Example 5 | | | | | | | |
| Comparative | 74.5 | 0.5 | 25 | 36000 | 0.26 | 4.32 | D |
| Example 6 | | | | | | | |
| Comparative | 70 | 5 | 25 | 37000 | 0.29 | 7.25 | D |
| Example 7 | | | | | | | |
| Comparative | 65 | 10 | 25 | 35000 | 0.26 | 9.25 | D |
| Example 8 | | | | | | | |
| Comparative | 55 | 20 | 25 | 36000 | 0.26 | 15.52 | D |
| Example 9 | | | | | | | |

TABLE 6

| | Raw Material Components of Copolymer | | | | | | | | |
|---|---|---|---|---|---|---|---|---|---|
| | (parts by mass) | | | | | | | | |
| | Specific | | | | Silicone | | | | |
| | Vinyl | Polar Group-Containing | | | | Color Particles | Volume Average | Total Charge | Mixed- |
| | Compound | Polymerization Component | | | Macromer | Titanium Oxide | Particle Diameter | Quantity | Color |
| | St | MAA | HEMA | DEAEMA | FM0721 | Particles | of Particles [μm] | [nC/cm²] | Display |
| Example 101 | 70 | 5 | — | — | 25 | 10 parts with | 0.21 | 5 | A |
| | | | | | | respect to 20 parts | | | |
| | | | | | | of copolymer | | | |
| Example 102 | 70 | — | 5 | — | 25 | 10 parts with | 0.25 | 6 | A |
| | | | | | | respect to 20 parts | | | |
| | | | | | | of copolymer | | | |
| Example 103 | 70 | — | — | 5 | 25 | 10 parts with | 0.24 | 6 | A |
| | | | | | | respect to 20 parts | | | |
| | | | | | | of copolymer | | | |
| Comparative | 75 | — | — | — | 25 | 10 parts with | 0.31 | 25 | C |
| Example 101 | | | | | | respect to 20 parts | | | |
| | | | | | | of copolymer | | | |

As shown in Tables 1 to 6, it is found that as compared to the comparative examples, the charge quantity of the white particles in the white particle dispersion liquid is small, mixed-color display is suppressed, and field responsiveness of the white particles is reduced in the examples.

Abbreviations in Tables 1 to 6 denote the following compounds.
St: styrene
VNp: 2-vinylnaphthalene
VBP: 4-vinylbiphenyl
DVB: Divinylbenzene (m, p mixture)
MAA: Methacrylic acid
CB-1:1-[2-(methacryloyloxy)ethyl]phthalate
FM0721: Silicone macromer (manufactured by Chisso Corporation, SILAPLANE FM-0721, weight average molecular weight: 5000. In Structural Formula (A), R¹ is a methyl group, R^{1′} is a butyl group, m is 68, and x is 3)
HEMA: 2-hydroxyethyl methacrylate
DEAEMA: 2-(diethylamino)ethyl methacrylate
MMA: Methyl methacrylate

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and there equivalents.

What is claimed is:

1. Display particles comprising:
a copolymer having a repeating unit corresponding to a vinyl compound represented by the Formula (1) and a repeating unit corresponding to a compound with a polar group and an ethylenically unsaturated bond:
ArH₂C═CH₂)ₙ Formula (1)
wherein Ar represents an unsubstituted aromatic ring or an aromatic ring substituted with an alkyl group having from 1 to 6 carbon atoms or an aryl group having from 6 to 12 carbon atoms, and
n represents an integer of from 1 to 4.

2. The display particles according to claim 1, further comprising color particles,
wherein each of the color particles are covered by a shell including the copolymer.

3. The display particles according to claim 1,
wherein the vinyl compound represented by the Formula (1) is at least one selected from the group consisting of styrene, divinylbenzene, vinylbiphenyl, divinylbiphenyl, vinylnaphthalene, and divinylnaphthalene.

4. The display particles according to claim 1,
wherein the vinyl compound represented by the Formula (1) is at least one selected from the group consisting of styrene, divinylbenzene, vinylbiphenyl, and vinylnaphthalene.

5. The display particles according to claim 1,
wherein a content of the repeating unit corresponding to the compound with the polar group and the ethylenically unsaturated bond is 0.1% by mass or greater and 20% by mass or less based on a total of the copolymer.

6. The display particles according to claim 1,
wherein a content of the repeating unit corresponding to the compound with the polar group and the ethylenically unsaturated bond is 5% by mass or greater and 20% by mass or less based on a total of the copolymer.

7. The display particles according to claim 1,
wherein a content of the repeating unit corresponding to the compound with the polar group and the ethylenically unsaturated bond is 10% by mass or greater and 20% by mass or less based on a total of the copolymer.

8. The display particles according to claim 1,
wherein a content of the repeating unit corresponding to the vinyl compound represented by the Formula (1) is 5% by mass or greater and 75% by mass or less based on a total of the copolymer.

9. The display particles according to claim 1,
wherein a content of the repeating unit corresponding to the vinyl compound represented by the Formula (1) is 5% by mass or greater and 65% by mass or less based on a total of the copolymer.

10. The display particles according to claim 1,
wherein a content of the repeating unit corresponding to the vinyl compound represented by the Formula (1) is 5% by mass or greater and 55% by mass or less based on a total of the copolymer.

11. The display particles according to claim 1,
wherein the copolymer further includes a repeating unit corresponding to a compound having a silicone chain.

12. The display particles according to claim 11,
wherein a content ratio of the repeating unit corresponding to the compound having a silicone chain is from 5% by mass to 50% by mass based on a total of the copolymer.

13. The display particles according to claim 11,
wherein a content ratio of the repeating unit corresponding to the compound having a silicone chain is from 10% by mass to 40% by mass based on a total of the copolymer.

14. A display particle dispersion liquid comprising:
a particle group including the display particles according to claim 1; and
a dispersion medium for dispersing the particle group.

15. A display medium comprising:
a pair of substrates, at least one of which has translucency, which are disposed with a space interposed therebetween;
a migrating particle group which is sealed between the pair of substrates and migrates in accordance with an electric field;
a display particle group which is sealed between the pair of substrates and includes the display particles according to claim 1; and
a dispersion medium which is sealed between the pair of substrates to disperse the migrating particle group and the display particle group.

16. A display device comprising:
the display medium according to claim 15; and
an electric field forming unit which forms an electric field between the pair of substrates.
